(19) United States
(12) Patent Application Publication
(10) Pub. No.: US 2010/0203491 A1
(43) Pub. Date: Aug. 12, 2010

(54) KARAOKE SYSTEM WHICH HAS A SONG STUDYING FUNCTION

(76) Inventor: Jin Ho Yoon, Seoul (KR)

Correspondence Address: The Belles Group, P.C., 1518 Walnut Street, Suite 1706, Philadephia, PA, 19102, US

(21) Appl. No.: 12/678,896

(22) PCT Filed: Sep. 12, 2008
(86) PCT No.: PCT/KR08/05422

§ 371 Date: Mar. 18, 2010

(30) Foreign Application Priority Data
Sep. 18, 2007 (KR) 10-2007-0094481
Apr. 22, 2008 (KR) 10-2008-0037008

(51) Int. Cl. G09B 5/00

(52) U.S. Cl. 434/307 A

(57) ABSTRACT

The present invention relates, in general, to a karaoke system, and, more particularly, to a karaoke system having a song learning function that enables a user to repeatedly listen to songs on a bar or length basis and enables the user to sing songs with accompaniment sounds. The present invention provides a system and method that enables the complete or bar-based singer's song to be repeatedly played back in response to a user's request, thereby enabling the user to sufficiently and conveniently practice one or more bard difficult to sing. The present invention provides a system and method that enables bar-based scores to be indicated, so that the user can be aware of one or more incorrect bars and can intensively practice the corresponding portions using the above-described function, thereby increasing the user's interest and enabling efficient learning.

### TECHNICAL FIELD

The present invention relates, in general, to a karaoke system, and, more particularly, to a karaoke system having a song learning function that enables a user to repeatedly listen to songs on a bar or length basis and enables the user to sing songs with accompaniment sounds.

### BACKGROUND ART

The development of multimedia technology as well as the development of computing technology has enabled various types of media services and business models based on the media services.

In particular, media services have been developed into various types of services including editing and streaming services related to content such as sounds and moving images. Various types of services can be provided through portable user terminals as well as Personal Computers (PCs). One of these services is a song accompaniment system (a karaoke system) that is provided to users. A singing practice system for enabling users to practice professional singers' songs through the accompaniment system has been implemented.

One of such technologies is a prior art method of controlling new song practice in a computer accompaniment system for songs (Korean Patent No. 0283800).

The proposed method of controlling new song practice is configured to store only the singers' voices of new songs in separate audio tracks in a universal Musical Instrument Digital Interface (MIDI) accompaniment system and selectively play back a singer's voice wave or accompaniment sounds in response to the user's selection of new song practice. In the case where a song is played back through a user's pressing of a new song practice key, a “singer's voice wave” is issued through a speaker along with accompaniment sounds. In contrast, in the case where playback is performed without the pressing of the new song practice key, the “singer's voice wave” is issued through a speaker along with “chorus wave” data.

A user who desires to practice a new song is enabled to select the song from among the songs in a new song list (songs for which singers' voices exist in separate tracks) and to practice the song while listening to the song including the singer's voice.

However, according to this method, the complete songs are practiced, so that it is impossible to separately practice weak portions of the songs and to select and listen to practiced portions of the songs, with the result that it is difficult to determine that actual song practice is performed.

Furthermore, in order to implement such a method, information in which only singers' voices are stored in audio tracks must be provided.

This method requires the separate management of singers' voices. In the case of new songs, this method can be implemented by separately storing only singers' voices for song practice during the production of the songs and using them. In contrast, the separation of only singers' voices from records released in the past requires a complicated process.

### DISCLOSURE OF INVENTION

Accordingly, the present invention has been made keeping in mind the above problems occurring in the prior art, and an object of the present invention is to provide a system and method that enables the singer's complete or bar-based song to be repeatedly played back in response to a user's request, thereby enabling the user to sufficiently and conveniently practice one or more bard difficult to sing.

Another object of the present invention is to provide a system and method that enables bar-based scores to be indicated, so that the user can be aware of one or more incorrect bars and can intensively practice the corresponding portions using the above-described function, thereby increasing the user's interest and enabling efficient learning.

A further object of the present invention is to provide a system and method that varies a score calculation method according to program setting mode (song learning mode or imitative singing mode), thereby stimulating the user's interest and increasing a learning effect based on the purpose.

Yet another object of the present invention is to provide a system and method that provides a recording function, a function of enabling the user to designate complete recording or bar-based recording in the setting of the recording function and then perform recording mode, and a function of integrating bar-based partial songs into a complete song thereby enabling the user to use the present invention for song learning in various manners.

### BRIEF DESCRIPTION OF DRAWINGS

FIG. 1 is a block diagram of a karaoke system having a song learning function according to the present invention;

FIG. 2 is a diagram showing an integrated file structure for storing locally stored content data, that is, accompaniment sound data and a singer's song data in a single integrated file according to the present invention;

FIG. 3 shows an example of a mode setting screen that is provided by the mode setting unit to a user in the present invention;

FIGS. 4 to 8 are diagrams illustrating a theoretical background for representing the extents of song learning and imitative singing in scores, wherein;

FIG. 4 is a diagram showing the waveforms of spectrum signals in the time plane,

FIG. 5 is a waveform diagram when different musical instruments produce sounds having the same pitch;

FIG. 6 is a diagram showing an example of reference spectrum information input for the measurement of tone color similarity;

FIG. 7 is a diagram showing an example of the input spectrum information of an audio signal input through a microphone for the measurement of tone color similarity;

FIG. 8 is a block diagram showing the detailed construction of a score calculation unit according to the present invention;

FIG. 9 is a block diagram showing another embodiment of the score calculation unit in the present invention;

FIG. 10 is a flowchart showing a song learning process for playing back a song in the mode set in the song learning system when a user selects a song to learn, in the present invention;

FIG. 11 shows an example of a song learning player displayed on the display unit according to the present invention;

FIG. 12 is a detailed flowchart showing an AR bar or MR bar repetition playback routine according to the present invention;

FIG. 13 is a diagram illustrating an arbitrary interval repetition learning method according to the present invention;

FIG. 14 is a flowchart showing a flow when recording mode is operated in such a manner as to record a complete song at one time;

FIG. 15 is a flowchart showing the flow of an operation in the case where a bar is selected as a recording unit in the program basic environment settings according to the present invention;

FIG. 16 is a flowchart showing the detailed operation of an MR bar repetition recording routine according to the present invention;

FIG. 17 is a flowchart showing a detailed operation of determining whether to store bar recorded data according to the present invention;

FIG. 18 is a flowchart showing a song learning score calculation process that is performed in song learning mode on a per-bar basis according to the present invention;

FIG. 19 is a flowchart showing the flow of the calculation of an imitative singing score according to the present invention;

FIG. 20 is a flowchart showing the flow of calculation of time scores in predetermined intervals according to the present invention;

FIG. 21 is a diagram showing an example of displaying bar-based scores for bars, sung using MR, when a complete song is terminated;

FIG. 22 is a block diagram showing the construction of a second embodiment of the karaoke system having a song learning function according to the present invention;

FIG. 23 is a block diagram showing the construction of an embodiment in which the song practice system of the present invention is applied to a digital sound player to which song accompaniment means is applied;

FIG. 24 is a block diagram showing the detailed construction of a song accompaniment control unit according to an embodiment of the present invention embodiment;

FIG. 25 is a block diagram showing the construction of a pitch adjustment unit according an embodiment of the present invention;

FIG. 26 is a diagram showing an example of spectrum shift in a pitch adjustment unit according to an embodiment of the present invention;

FIG. 27 is a block diagram showing the construction of a speed adjustment unit according to an embodiment of the present invention;

FIG. 28 is a diagram illustrating decimation and interpolation according to an embodiment of the present invention;

FIG. 29 is a block diagram showing the construction of an echo creation unit according to an embodiment of the present invention;

FIG. 30 is a waveform diagram showing the output signal of the echo creation unit according to an embodiment of the present invention; and

FIG. 31 is a flowchart showing the control flow of a karaoke function during a call in an embodiment of the present invention in which the song accompaniment and song practice system of the present invention is applied to a mobile phone.

### MODE FOR THE INVENTION

A karaoke system having a song learning function according to the present invention includes content storage means for storing accompaniment sound (MR) and singers'song (AR) data for song practice, key input means for enabling a user to input user control values related to the selection of songs and the control of playback/recording, recorded data storage means for storing the user's singing data during the user's song practice, text display control means for processing text captions, such as lyrics captions and scores, for display means, display means for displaying lyrics, scores and screens for song practice, an audio conversion codec for converting digital signals into analog signals so as to output the accompaniment sounds and the singers' songs stored in the content storage means or converting the user's voice analog signals input through a microphone into digital signals, the microphone for converting the user's voice into electrical signals, a network interface for connecting to a predetermined network; and control means for providing accompaniment sounds or a singer's song according to the user's selection and providing a series of control processes related to playback/recording for the user's song practice.

The control means includes:

a mode setting unit for providing a process for setting the operating mode for song practice and storing the operating mode selected by the user,

a score calculation unit for calculating a score for the user's practice during the user's song practice, and

a song practice control unit for controlling playback/recording of accompaniment sounds or singers' songs stored in the content storage unit according to an environmental setting value set in the mode setting unit.

The construction of the present invention will be described in detail below with reference to embodiments shown in the accompanying drawings.

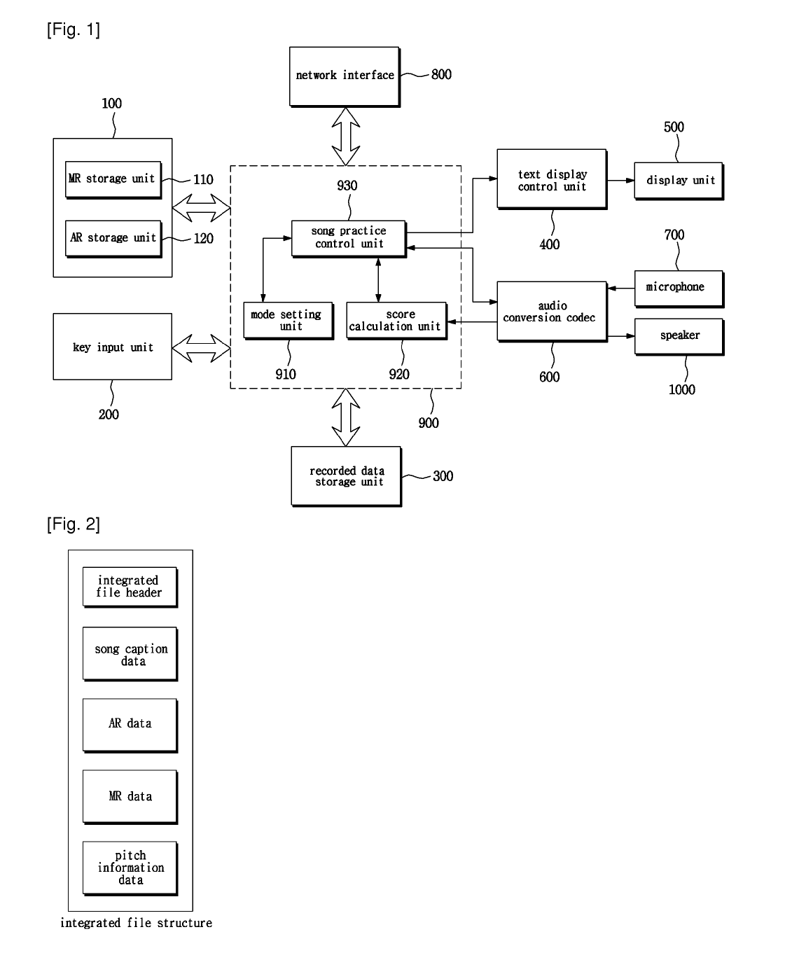

FIG. 1 shows the configuration of the first embodiment of the song learning system of the present invention.

The song learning system includes:

a content storage unit 100 for storing accompaniment sound (MR) and singers' song (AR) data for song practice,

a key signal input unit 200 for enabling input of user key signals related to selection of songs and control of playback/recording,

a recorded data storage unit 300 for storing the user's singing data during the user's song practice,

a text display control unit 400 for processing text captions, such as lyrics captions and scores, for display means,

a display unit 500 for displaying lyrics, scores and screens for song practice,

an audio conversion codec 600 for converting digital signals into analog signals so as to output the accompaniment sounds and the singers' songs stored in the content storage unit 100 or converting the user's voice analog signals input through a microphone 700 into digital signals,

the microphone 700 for converting the user's voice into electrical signals,

a network interface 800 for connecting to a predetermined network and

a control unit 900 for providing accompaniment sounds or a singer's song according to the user's selection and providing a series of control processes related to playback/recording for the user's song practice.

The content storage unit 100 includes an accompaniment sound storage unit 110 for storing accompaniment sounds and a singers' songs storage unit 120 for storing accompaniment sounds including singers' songs.

The control unit 900 includes a mode setting unit 910 for providing a process for setting the operating mode for song practice and storing the operating mode selected by the user, a score calculation unit 920 for calculating a score for the user's practice during the user's song practice, and a song practice control unit 930 for controlling playback/recording of accompaniment sounds or singers' songs stored in the content storage unit according to an environmental setting value set in the mode setting unit.

Meanwhile, the score calculation unit 920 includes:

a pitch data extraction unit 921 for extracting reference pitch information from musical pitch information contained in content data provided in advance by a content provider in line with accompaniment sounds on the basis of time synchronization information calculated from caption time information for display of lyrics captions contained in accompaniment sounds data by the song practice control unit 930,

a first spectrum analysis unit 922 for analyzing a spectrum of the user's voice input through the microphone 700 on the basis of the time synchronization information,

a voice extraction unit 923 for extracting the singer's voice data from the singer's song data,

a second spectrum analysis unit 924 for analyzing the spectrum of the voice extracted by the voice extraction unit 923,

a song learning score calculation unit 925 for calculating a song learning score by receiving reference pitch information from the pitch data extraction unit 921, comparing the reference pitch information with user pitch information obtained through the analysis by the first spectrum analysis unit 922 and acquiring time from lyrics inversion information, and

an imitative singing score calculation unit 926 for calculating an imitative singing score by comparing reference spectrum information obtained through the analysis of the singers' song data by the second spectrum analysis unit 924 with the user's tone color obtained through the spectrum analysis of the user's voice by the first spectrum analysis unit 922 and acquiring the time from the lyrics inversion information.

The song learning score calculation unit 925 includes a pitch accuracy measurement unit 925a for measuring the accuracy of the pitch by receiving the reference pitch information from the pitch data extraction unit 921, receiving the analyzed user pitch information from the first spectrum analysis unit, and comparing the reference pitch information with the user pitch information, a pitch transition similarity measurement unit 925b for storing previous pitch data, calculating pitch transition by comparing the stored previous pitch data with the spectrum analysis information currently input from the first spectrum analysis unit 922, and measuring similarity between the calculated pitch transition, that is, reference information, and pitch transition of a song that is sung by the user, a time score measurement unit 925c for calculating a time score by comparing lyrics letter inversion time information with actually input user's input data, an adder 925d for calculating a song learning score by summing score values calculated by the pitch accuracy measurement unit 925a, the pitch transition similarity measurement unit 925b and the time score measurement unit 925c, and a score provision unit 925e for calculating and then providing a score according to the environmental setting value set through the mode setting unit 910 using the instantaneous scores of respective bars through the adder 925d.

The imitative singing score calculation unit 926 includes:

a tone color similarity measurement unit 926a for receiving the spectrum analysis information of the singer's voice, extracted from the singer's song from the second spectrum analysis unit 924, as reference spectrum information, receiving the spectrum information of the user's voice from the first spectrum analysis unit 922, and measuring tone color similarity,

a tone color transition similarity measurement unit 926b for calculating tone color transition through comparison with the spectrum analysis information input from the first spectrum analysis unit 922, and measuring similarity between the calculated tone color transition, that is, reference information, and tone color transition of the user's song,

a time score measurement unit 926c for calculating time score by comparing the lyrics letter inversion time information with actually input user's input data,

an adder 926d for calculating a song learning score by summing score values calculated by the tone color similarity measurement unit 926a, the tone color transition similarity measurement unit 926b and the time score measurement unit 926c, and

a score provision unit for calculating and then providing a score according to the environmental setting value set through the mode setting unit 910 using instantaneous scores of respective bars through the adder 926d.

The above-described karaoke system of the present invention is a system in which accompaniment sounds and singers' songs in which singers' voices are included in accompaniment sounds are stored and used in a local system.

The content storage unit 100 refers to storage means capable of independently performing storage without the aid of a network; such as a Compact lick (CD) or a hard disk.

The content storage unit 100 stores accompaniment sounds (MR; Music Recorded) and singers' songs (AR; All Recorded), and the MR and the AR use digital source sounds (MP3, AAC, WMA, MP2, or AC3 sounds) rather than MIDI format sounds.

As shown in FIG. 2, accompaniment sounds and accompaniment sounds including singers' songs need not be separately constructed, but may be constructed in a single integrated file.

FIG. 2 shows an integrated file structure for storing accompaniment sound data and a singer's song data in the form of a new single integrated file so as to provide the efficiency of service for content stored in a local system and the efficiency of storage and management.

The integrated file is constructed to manage singers' song (AR) data, accompaniment sound (MR) data and song caption data in a single file.

An integrated file header representative of an integrated file is provided, and then song caption data, AR data, MR data and pitch information data are constructed.

The integrated file header includes pointer values for data located after the integrated file header, data length information or the like.

Using this information, the locations of song caption data, AR data, MR data and pitch information data in an integrated file can be found.

Here, it is preferred that the accompaniment sounds MR and singers' songs AR which are used be synchronized with each other.

That is, in order to prevent playback from being interrupted or repeated when accompaniment sounds or singers' songs are selected in the middle of a playback when the accompaniment sounds and the singers' songs are being played back at the same time, the accompaniment sounds MR and the singers' songs should be synchronized with each other.

In such an implementation, it is possible to construct a single piece of lyrics information, rather than to construct respective pieces of lyrics information for the accompaniment sounds and the singers' songs.

That is, it is not necessary to separately construct lyrics information suitable for accompaniment sounds and lyrics information suitable for singers' songs.

The lyrics information includes time information about the times when corresponding lyrics are displayed on a screen after the start of a song.

In the case where accompaniment sounds MR and singers' songs AR are not synchronized with each other, separate pieces of caption information should be constructed as lyrics information for accompaniment sounds MR and lyrics information for the singers' songs AR.

Since normally the starting time of lyrics may vary for accompaniment sounds MR and singers' songs AR, lyrics information used should include data about at least line-based song captions and information about the starting and ending times of line-based song captions in order to smoothly perform bar-based repetition.

Furthermore, many pieces of data among singers' song (AR) data may include separate song caption data.

In this case, it is possible to separately construct and use only time information indicative of the line-based starting times of song captions suitable for singers' songs (AR) data.

The above-described karaoke system may be applied to a mobile phone, a car navigation system, an MP3 player, a PDA, a Portable Multimedia Player (PMP), a CD player, a DVD player, an IP TV or a set-top box, the system for which may be implemented using typical software, as well as a Personal Computer (PC). The implementation in a hand-held system will be described in another embodiment of the present invention.

The key input unit 200 is means for enabling a user to select a specific key for song practice, and allows a user to select a song operating mode or the like.

The text display control unit 400 is means for displaying corresponding lyrics on the display unit 500, such as an LCD or a TV, when a singer's song and accompaniment sounds are played back.

The recorded data storage unit 300 is means for storing recorded data for a user's practice, that is, a user's voice, and a user's recorded data together with selected accompaniment sounds are stored in the recorded data storage unit in the form of a file.

The audio conversion codec 600 is means for converting analog signals into digital signals and digital signals into analog signals, and converts digital signals into analog signals in order to output accompaniment sounds played through a speaker and analog signals into digital signals in order to store signals input through the microphone 700.

The microphone 700 is means for converting a user's input voices into electric signals.

Although the microphone 700 is not an element indispensable to a user's song practice, the microphone 700 is used to enable a user to perform practice while listening to the user's voice through the speaker 1000 and to receive a user's voice in order to record the user's voice.

In practice, most devices, such as a car navigation system, do not include microphones or connection terminals for microphones, in which case focus is placed on the provision of a song practice function, rather than the provision of a user's voice input function.

The microphone 700 may be configured to be of an external type, and a microphone input terminal may be used as interface means for connecting the microphone.

The network interface unit 800 is means for enabling the sharing of data with a predetermined server or an external user over a network such as the Internet or a local network.

The control unit 900 is means for providing a process for controlling respective units according to the operating mode and a function that are selected by a user.

The mode setting unit 910 of the control unit 900 is means for enabling a user to set the operating environment of the system and storing the set data.

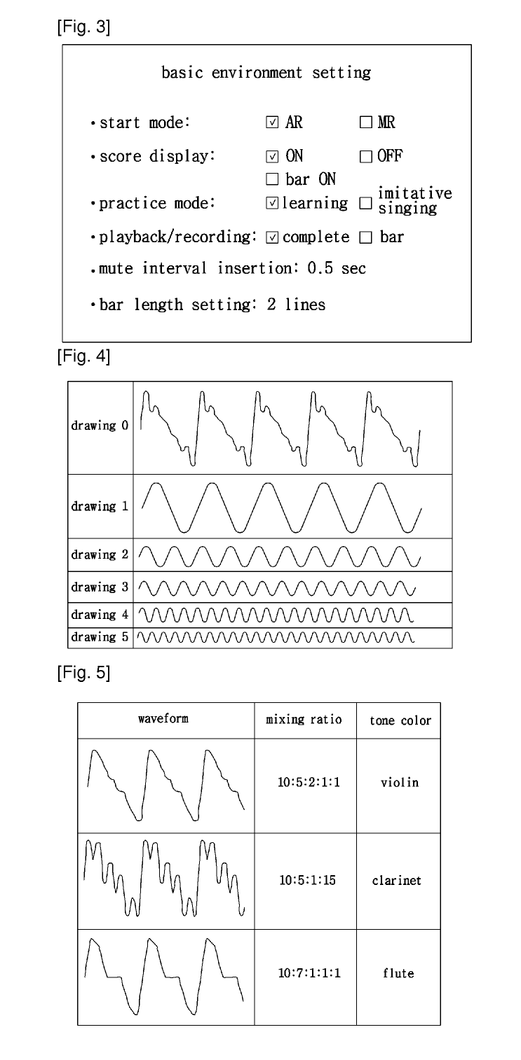

FIG. 3 shows an example of a mode setting screen that is provided by the mode setting unit 910 to a user.

The mode setting information includes start mode for selecting data (accompaniment sounds or a singer's song) to be played back when the learning content 100 is played back first, score display mode for selecting whether to display scores, practice mode for setting song learning mode or imitative singing practice mode, and playback/recording unit mode for setting whether to perform playback on a complete song basis or to perform playback and recording on a per-bar basis.

The mode setting information further includes time setting mode for inserting one or more mute pitches and bar length setting mode for setting the length of bars when playback is performed on a per-bar basis.

Meanwhile, the score display mode may further include setting information about whether to display scores on a per-bar basis.

Start mode is mode for determining whether to play back MR or AR when a song starts to be played back.

Practice mode is mode for determining whether to place evaluation score calculation criteria in learning mode or in imitative singing mode.

Learning mode is intended to enable a user to practice a song and uses score evaluation criteria including the time, the pitch, and the similarity between actual pitch transition and the pitch transition of the original song.

Imitative singing mode is intended to enable a user to imitate the singer's voice in the original song and uses score evaluation criteria including the time, the tone color, and the similarity between actual tone color transition and the tone color transition of a singer's voice.

The playback/recording unit is used to determine whether to record the complete song at one time or to record respective bars and produce a final single song.

The mute pitch insertion is used to determine the length of mute pitches between bars during bar repetition.

The bar length setting unit is a unit for determining the length of a bar.

The reference default is two lines.

The reason for this is that two caption lines may be displayed on a single screen in a karaoke parlor.

It is possible for a user to set the number of caption lines that constitute a single bar.

The score display mode is used to determine whether to display scores, and is used to determine whether to display scores for respective bars during the complete playback.

FIGS. 4 to 8 are diagrams illustrating a theoretical background for representing the extent of song learning and imitative singing by means of scores.

In the song learning mode, the score calculation criterion includes the accuracy of the time, pitch and pitch transition of a song. In contrast, in the imitative singing mode, the score calculation transition is similarity with the time, tone color and tone color transition of the singer.

The definitions of the pitch and tone color will be described as follows:

If a certain audio waveform is f(t), f(t) is a function representative of the variation in atmospheric pressure or gaseous density over time t. Assuming that A, B, C and D are constants representative of amplitudes and a, b, c and d are constants representative of frequencies, f(t) may be expressed as the following Equation 1:

MathFigure 1

f(t)=A sin at+B sin bt+C sin ct+D sin dt [Math. 1]

Any type of wave can be thought of as a sum of sine waves.

The values of A, B, C, D, . . . and the values of a, b, c, d, . . . vary with the type of wave.

Here, if A is far greater than other values, humans sense a corresponding frequency a as a pitch.

Furthermore, the other sine waves included in f(t) contribute to the humans' sensing of the tone color.

Humans sense a specific tone color according to the ratio between A, B, C, D, . . . , which are the magnitudes of sine waves having respective frequencies a, b, c, d, . . . .

When a musical instrument, such as a string instrument or a wind instrument, produces a sound, a fundamental and overtones natural multiples of the fundamental are issued together.

Since the amplitude or magnitude of the fundamental is far greater than that of other overtones, humans can identify the frequency of the fundamental using the pitch.

In the case of a percussion instrument such as a drum the magnitude of the overtones thereof is similar to that of the fundamental thereof with the result that it is difficult to find pitch.

FIG. 4 is a diagram showing the waveforms of spectrum signals in the time plane.

In FIG. 4, the first drawing 0 shows an arbitrary waveform,

drawing 1 shows a sine wave having a frequency of f0 and an amplitude of 10,

drawing 2 shows a sine wave having a frequency of 2f0 and an amplitude of 4,

drawing 3 shows a sine wave having a frequency of 3f0 and an amplitude of 3,

drawing 4 shows a sine wave having a frequency of 4f0 and an amplitude of 3, and

drawing 5 shows a sine wave having a frequency of 5f0 and an amplitude of 2.

Here, the sum of the sine waves of drawings 1˜5 results in the wave of drawing 0.

That is, the sum of the sine waves having respective frequencies of f0, 2f0, 3f0, 4f0 and 5f0 at a ratio of 10:4:3:3:2 results in waves in complex form, as shown in drawing 0.

When the ratio between these amplitudes varies, the shape of a resulting wave varies.

When a specific wave is divided into sine waves and the mixing ratio of the sine waves for respective frequencies is represented in a table or graph, a spectrum is obtained.

The greatest frequency of a sine wave determines the pitch of a corresponding sound.

Therefore, when humans hear a sound wave, such as that shown in the drawing 0 of FIG. 4, they think of the pitch thereof as the frequency f0 of drawing 1.

The ratio between sine waves determines the shape of a wave, that is, the tone color.

The pitch of the center key La of a piano is 440 Hz.

Meanwhile, when the key is pressed, not only a sound having a frequency of 440 Hz is produced, but sounds having frequencies of 880 Hz, 1760 Hz, 3520 Hz and 7040 Hz, which are 2, 3, 4, 5, . . . times 440 Hz, are produced together with the sound having a frequency of 440 Hz.

However, since the magnitude of a sound having a frequency of 440 Hz is greatest, humans sense the pitch of the sound as La.

The ratio between the remaining overtones determines the tone color of the piano.

The reason why La produced by a guitar and La produced by a violin have the same pitch and different tone colors is that the ratio between overtones varies with each musical instrument.

The reason why a sound produced by a Stradivarius violin differs from a sound produced by a typical violin is that the mixing ratios of overtones thereof slightly differ from each other.

FIG. 5 is a waveform diagram when different musical instruments produce sounds having the same pitch.

The uppermost waveform is a waveform similar to that of the sound of a violin, the center waveform is a waveform similar to that of the sound of a clarinet, and the lowermost waveform is a waveform similar to that of the sound of a flute.

From this table, it can be seen that the waveform varies with a fundamental frequency and the mixing ratio of overtones, with the result that the tone color sensed by humans varies accordingly.

The present invention provides a method of calculating song scores using the above-described characteristics of tone color information.

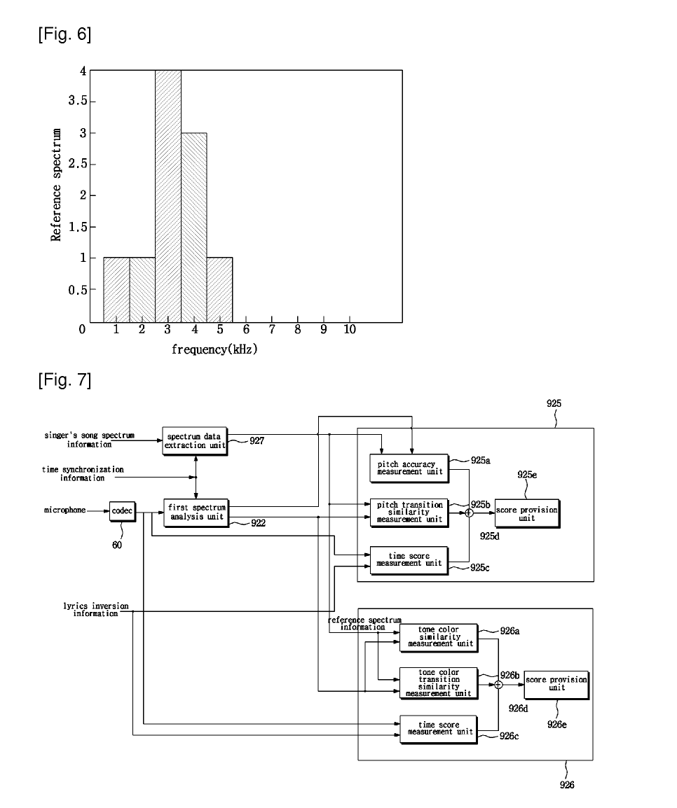

FIGS. 6 and 7 show spectrum waveforms illustrating an example of measuring similarity, wherein FIG. 6 shows an example of reference spectrum information input for the measurement of tone color similarity, and FIG. 7 shows an example of the input spectrum information of an audio signal input through a microphone for the measurement of tone color similarity.

There are various means that can be used to measure similarity.

This method is similar to a method of measuring the similarity between two vectors.

For example, a correlation value, a normalized correlation value, a correlation coefficient, and an Euclidean distance for a method of measuring the distance between two vectors may be used for the measurement of similarity.

In the present invention, as an example, the similarity between two tone colors is measured using the correlation coefficient.

Here, since the tone colors can be expressed using frequency spectra, the measurement of the similarity between two tone colors is the same as the measurement of the similarity between spectra.

The characteristics of the correlation coefficient eliminate an average value and perform normalization to two respective vector sizes, before the calculation of the correlation between two vectors.

Accordingly, the similarity can be measured regardless of the level of sounds.

Assuming that reference music information spectrum X=[1,1,4,3,1,0,0,0,0,0] and the spectrum of a user's audio signal input through the microphone Y=[1,2,1,1,1,0,0,0,0,0], the correlation coefficient between two spectra is acquired using the following Equation 2.

FIGS. 6 and 7 are diagrams representing X and Y in a frequency plane.

$$\begin{matrix}MathFigure 2 \\ CC = \frac{( \tilde{X} \cdot \tilde{Y} )}{\sqrt{( \tilde{X} \cdot \tilde{Y} ) ( \tilde{Y} \cdot \tilde{Y} )}}\end{matrix} \qquad [ Math .2 ]$$

where

\ddot{X}=(X− X̅),and Ÿ=(Y− Y̅)

are values obtained by subtracting the average values of vectors from respective vectors, and ‘·’ is the inner product between two vectors. CC is the correlation coefficient between the two vectors.

The size of the absolute value is proportional to the similarity between the two vectors.

The range of the CC value is expressed by the following Equation 3:

MathFigure 3

−1≦CC≦1 [Math. 3]

The correlation coefficient value between X and Y obtained using the above Equation is 0.56.

The closeness of the correlation coefficient value to 1 indicates that the two vectors have high similarity.

The similarity between two spectra indicates that two audios under consideration have similar tone colors.

A tone color transition similarity value is a value that is obtained by measuring similarity using a value obtained by subtracting a previous spectrum value from a current spectrum value.

In the above Equation 2, the correlation coefficient is obtained using and

[symbol]

and [symbol] values [symbol] =(ΔX−Δ X̅)

where

ΔX=X_{NOW}−X_{PREW}

and

ΔY=Y_{NOW}−Y_{PREW}

.

X_{NOW}

and

Y_{NOW}

represent a current reference music information spectrum and the spectrum of the user's audio currently input through the microphone, respectively, and

X_{PREW}

and

Y_{PREW}

represent spectra at the immediately previous time.

A method of acquiring tone color transition similarity is the same as the previously described method of acquiring tone color similarity.

The reason why tone color transition similarity is measured is to measure similarity in music melody transition.

The similarity in melody transition is proportional to the similarity.

In the case where the value is high, it may be determined that the user sings a song very well.

The closeness of the value to 1 indicates that the user sings a song in a manner similar to that of the melody transition of a singer's song. A method of acquiring pitch transition similarity is the same as the method of acquiring the previously described method of acquiring tone color similarity.

Only the replacement of pitch transition over time with the tone color spectrum is required.

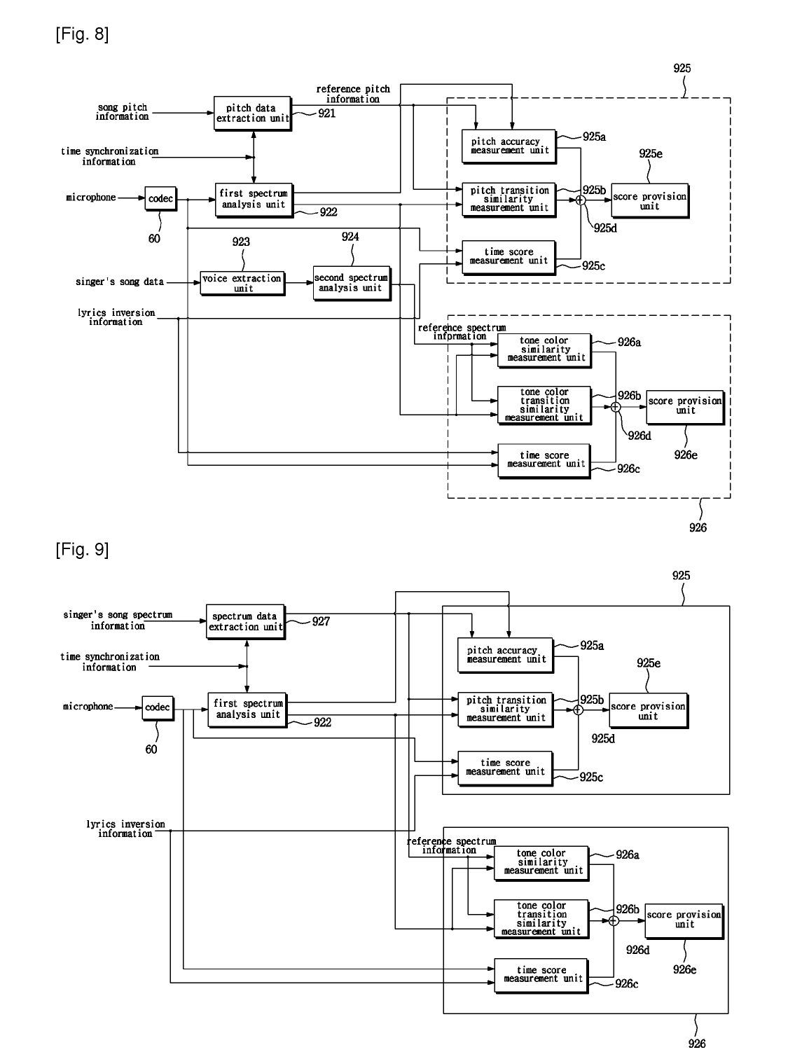

FIG. 8 shows the detailed construction of the score calculation unit that is constructed based on the above-described technical background.

A song learning score is calculated based on the time, the accuracy of the pitch and the pitch transition similarity, while an imitative singing score is calculated based on the time, the tone color similarity and the tone color transition similarity.

The period of the calculation of a score is given in the time synchronization information and the time synchronization information is determined depending on the caption time information for the display of lyrics captions, which is included in the accompaniment sounds data.

Since the period of spectrum calculation is determined based on the time synchronization information, the period may vary with the performance of the complete song learning system.

With regard to the song pitch information, each content provider calculates pitch information in line with each piece of accompaniment sound (MR) data in advance and provides it as data information.

At a specific time, the pitch data extraction unit extracts necessary pitch data.

The extracted pitch data is basic pitch data, and is reference input to the pitch accuracy measurement unit 925a and pitch transition similarity measurement unit 925b of the song learning score calculation unit 925.

The first spectrum analysis unit 922 analyzes a user's voice input through the microphone 700, and provides reference pitch information for the pitch accuracy measurement unit 925a and pitch transition similarity measurement unit 925b of the song learning score calculation unit 925.

The pitch accuracy measurement unit 925a is means for measuring similarity by comparing reference pitch data with the calculated value of a user's voice.

The pitch of a user's voice is estimated using the spectrum analysis information of the first spectrum analysis unit 922 for a user's voice input through the microphone 700.

Here, a frequency band having the highest energy is extracted and is considered to be the pitch of the user's voice.

The extent of similarity is measured by numerically comparing instantaneous voice pitch data with reference pitch data.

If a small difference is obtained as the result of the comparison, it is considered that a song has been sung at accurate pitch.

The pitch transition similarity measurement unit 925b quantitatively measures the similarity between the pitch transition of a song sung by a user and actual reference pitch transition.

In order to calculate pitch transition, previous pitch data is stored, and is used to measure similarity.

The time score measurement unit 925c checks whether a user's voice data has actually been input through the microphone 700 at lyrics letter inversion time, and calculates a time score.

The adder 925d is means for creating an instantaneous score by summing the results of the three types of comparison, that is, the outputs of the pitch accuracy measurement unit 925a, the pitch transition similarity measurement unit 925b and the time score measurement unit 925c.

The score provision unit 925e is means for providing scores for respective bars according to a condition value set through the mode setting unit 910 by using the calculated instantaneous score as input and providing the overall score by summing instantaneous scores for respective bars.

The imitative singing score calculation unit 926 is operated in such a manner as to measure the similarity between the spectrum information of a singer's voice and the spectrum information of a user's voice and provide a score in proportion to the similarity.

The voice extraction unit 923 is means for extracting only a singer's voice from a singer's song data, and extracts a voice using a voice extraction algorithm.

Since a typical singer's song is configured in the form of accompaniment sounds+the singer's voice, reference spectrum information should be obtained by extracting only the singer's voice from the singer's song.

The technologies that have been researched and disclosed are used as the algorithm for extracting only the voice, with the result that detailed descriptions thereof will be omitted here.

The second spectrum analysis unit 924 analyzes the spectrum of the singer's voice data extracted by the voice extraction unit 923, and provides the reference spectrum information to the tone color similarity measurement unit 926a and the tone color transition similarity measurement unit 926b.

The second spectrum analysis unit 924 buffers voice data for a predetermined amount of time, and then calculates spectrum information in line with time synchronization information.

The tone color similarity measurement unit 926a is means for measuring tone color similarity by comparing the reference spectrum information provided by the second spectrum analysis unit 924 with the spectrum information about the user's voice provided by the first spectrum analysis unit 922.

The tone color similarity measurement unit 926a measures the similarity between two pieces of input spectrum data, and provides the result in the form of a quantitative numerical value.

The tone color transition similarity measurement unit 926b measures the similarity between the time variations of pieces of input spectrum data in the form of a quantitative numerical value.

The time score measurement unit 926c checks whether data has actually been input through the microphone at lyrics letter inversion time, and calculates a time score.

The adder 926d is means for calculating an imitative singing instantaneous score by summing the outputs of the tone color similarity measurement unit 926a, the tone color transition similarity measurement unit 926b and the time score measurement unit 926c.

The score provision unit 926e is means for, according to a value set through the mode setting unit 910, providing instantaneous scores created for respective bars of imitative singing or providing the overall score obtained by summing the instantaneous scores for respective bars.

However, since the pitch information incurs high computational load, it may be difficult to construct it in most terminals. Accordingly, in this case, it is possible to simply calculate a score solely in consideration of time. It is possible to obtain a time score by comparing the lyrics inversion information with the user's voice input through the microphone 700, and calculate a score using the time score.

Another embodiment of the score calculation unit 290 of the present invention may be configured to further include a spectrum data extraction unit for storing in advance the spectrum information of singers' songs in the content storage unit 100, extracting spectrum data from this information, and providing the spectrum data as the reference spectrum information, thereby providing the imitative singing score.

The construction thereof is shown in FIG. 9.

There may be a system that has difficulty in extracting a voice from the singers' song data and acquiring reference spectrum information from this information in real time.

In order to overcome this problem, it is possible to extract a singer's voice from singers' song data in real time and calculate spectrum information from the extracted singer's voice.

The spectrum data extraction unit 927 is means for extracting spectrum information from the singers' song spectrum information in line with the time synchronization information and providing the extracted information as reference spectrum information, thereby calculating an instantaneous score.

The spectrum analysis is used to convert audio data on the time axis into frequency spectrum information.

Widely used algorithms may include Discrete Fourier Transform (DFT), Fast Fourier Transform (FFT), wavelet transform and Discrete Cosine Transform (DCT).

The FFT algorithm is most widely used.

The spectrum information includes the “time, spectrum, and additional information.”

Here, the time information is calculated as the time when the spectrum was calculated, that is, the time offset from the starting time of a song.

The spectrum information is the spectrum information of input audio signals calculated in the time information, and includes the spectrum information of a singer's actual voice.

Furthermore, the additional information is data that is additionally required for the calculation of the instantaneous scores.

The operation of the first embodiment of the present invention will be described below.

As a user selects a desired song and performs mode setting (the operating mode and a function) using the key input unit 200, the control unit 900 provides accompaniment sounds or a singer's song data through the content storage unit 100.

Here, the control unit 900 displays lyrics for a song being played on the display unit 500 through the text display control unit 400 as text, so that a user can view the lyrics and sing or learn the song.

The operating mode may be divided into general playback mode and practice mode, and the practice mode may be divided into song learning mode and imitative singing mode.

The user may select any one of the song learning mode and the imitative singing mode using the mode setting unit 910, in which case the user can select any one of the complete song and a bar as a playback/recording unit and perform playback.

In the practice mode, in the case where the complete song is selected, the complete song is repeatedly played back. In contrast, in the case where the bar is selected, playback is performed according to the length of the bar set through the mode setting unit 910.

Generally, the length of the bar is set to 2 lines.

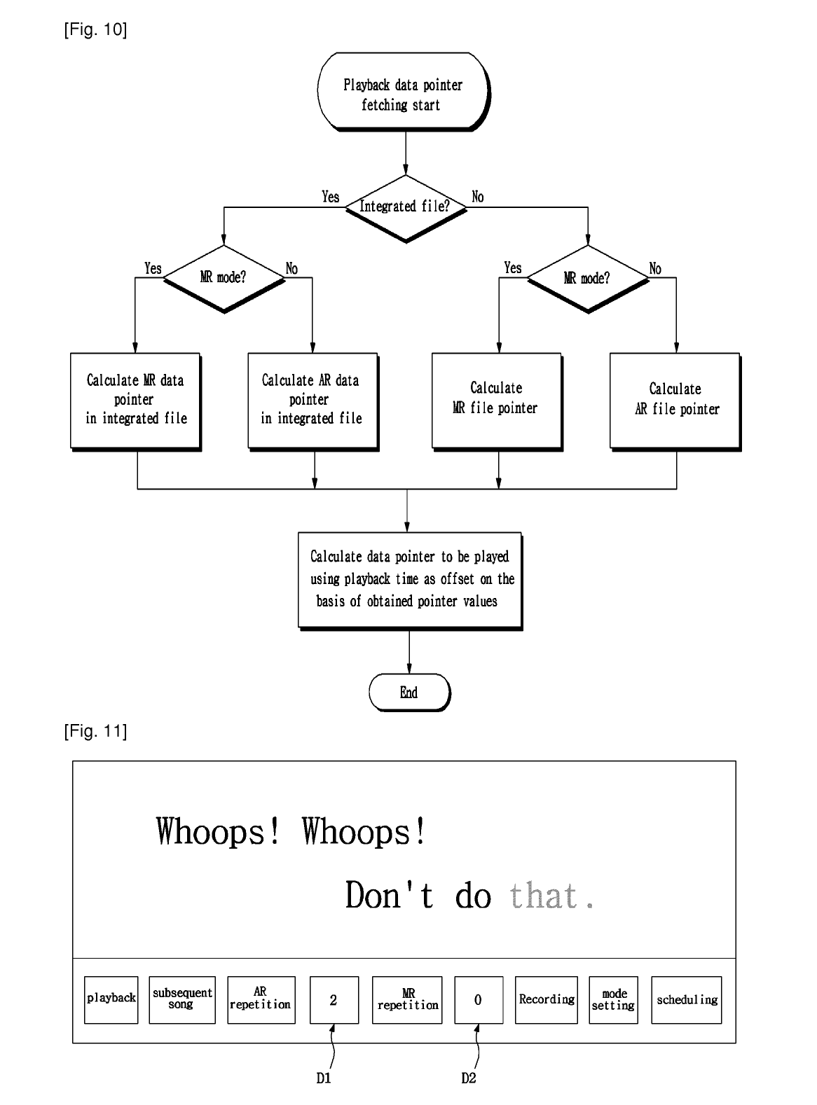

FIG. 10 shows a song learning process for playing back a song in the mode set in the song learning system when the user selects a song to learn.

The song learning process includes:

a mode determination step of determining whether the current mode is MR mode or AR mode,

a file determination step of determining whether a content file selected by a user is an integrated file or a separate file in which a singer's song AR or accompaniment sounds MR are separately provided,

a process of, if the current file is an integrated file and the current mode is MR mode, calculating a location pointer value of MR data recognized through an integrated file header, and, if the current file is an integrated file and the current mode is AR mode, calculating a location pointer value of AR data recognized through the integrated file header,

a step of, if the current file is not an integrated file and the current mode is MR mode, selecting an MR file corresponding to a currently selected file name and calculating a file pointer, and, if the current file is not an integrated file and the current mode is AR mode, selecting an AR file corresponding to a currently selected file name and calculating a file pointer,

a playback point calculation step for setting the calculated pointer to a reference pointer, obtaining a data offset value corresponding to current playback time, and adding the current playback time to the reference pointer,

a playback step of performing playback using the calculated playback pointer value,

a step of determining whether the playback has completed, and, if the playback has completed, checking whether repetition mode has been set, and

a step of, if the repetition mode has been set, repeating the playback a number of times set by the user using the playback pointer value, and, if the repetition mode has not been set, terminating the process.

The above-described process will be described in sequence below.

Whether the current mode is MR mode or AR mode is determined.

Whether a content file selected by the user is an integrated file or a separate file in which a singer's song AR or accompaniment sounds MR are separately provided is determined.

If the current file is an integrated file and the current mode is MR mode, the location pointer value of MR data recognized through an integrated file header is calculated. In contrast, if the current file is an integrated file and the current mode is AR mode, the location pointer value of AR data recognized through the integrated file header is calculated.

If the current file is not an integrated file and the current mode is MR mode, an MR file corresponding to a currently selected file name is selected and a file pointer is calculated. In contrast, if the current file is not an integrated file and the current mode is AR mode, an AR file corresponding to a currently selected file name is selected and a file pointer is calculated.

The calculated pointer is set to a reference pointer, a data offset value corresponding to current playback time is obtained, and the current playback time is added to the reference pointer.

Playback is performed using the calculated playback pointer value.

The current mode observes a value set through the mode setting unit 910. If MR repetition or AR repetition has been selected, the current mode is switched to repetition mode and then playback is performed.

FIG. 11 shows an example of a song learning player displayed on the display unit.

The upper portion of a screen is a portion for displaying the lyrics of a song and the lower input portion of the screen is a portion for displaying the user's selection of input and the number of times.

With regard to the input function, a playback button functions to play back a currently selected song and a next song button functions to stop a song being currently played, select a song immediately next to the song being currently played from among songs in a playback list, and play back the selected song.

If AR repetition playback is not being performed when the AR repetition button is pressed, the AR repetition button functions to stop the playback of a song being currently played, immediately move to the first position of the current bar of an AR song and perform playback.

If the AR repetition button is pressed again when AR repetition playback is being performed, the number of repetitions D1 is increased by 1, and is indicated beside the button.

Thereafter, whenever AR repetition is performed, the number of repetitions D1 is decreased by 1.

Here, when the AR repetition button is pressed during MR repetition, the MR song being currently played is stopped upon pressing the MR repetition number indication D2 is set to 0, movement to the first position of the corresponding bar of the AR is made, and AR repetition is performed.

If MR repetition playback is not being performed when the MR repetition button is pressed, the song currently being played is stopped, movement to the first position of the current bar of the MR is made, and playback is performed.

When the MR repetition button is pressed again during MR repetition playback, the repetition number indication D2 is increased by 1, and a repetition number is indicated beside it.

Whenever MR repetition is performed once, the number is decreased by 1.

When the MR repetition button is pressed during AR repetition, an AR song currently being played is stopped upon pressing the AR repetition number indication D1 is set to 0, movement to the first position of the corresponding bar of an MR song is made, and MR repetition is performed.

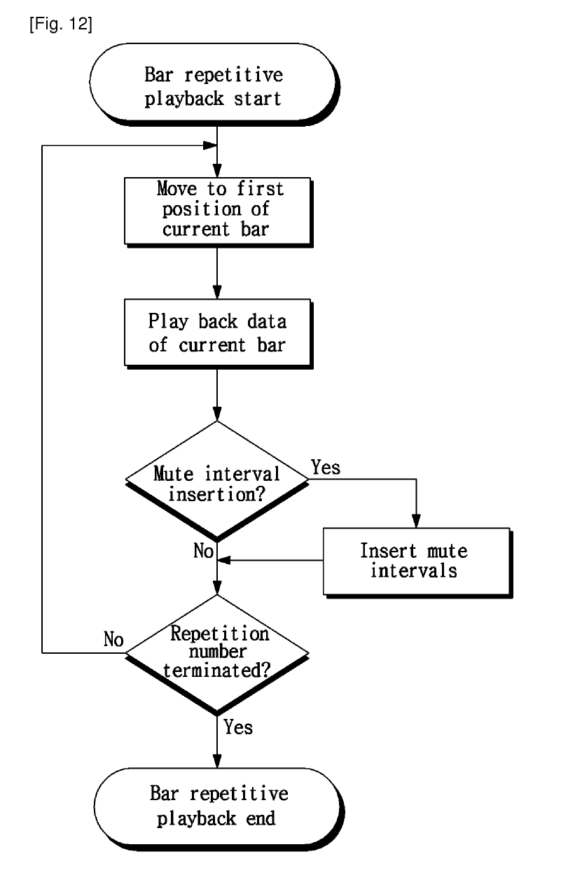

FIG. 12 is a detailed flowchart showing an AR bar or MR bar repetition playback routine.

The repetition playback routine includes:

the step of, when the AR (MR) repetition key is pressed, stopping a song currently being played and moving to the first position of a current bar of the currently selected AR (MR) song,

the step of playing back the AR (MR) data of the current bar,

the mute pitch determination step of, if the AR (MR) data playback of the current bar has completed, determining whether a mute pitch insertion value has been set in the mode setting unit,

the mute pitch insertion step of, if the mute pitch value has been set, inserting mute pitches between bars and bar playback at corresponding lengths using the mode set value set in the mode setting unit, and

the bar repetition playback step of determining whether the repetition number has been terminated, if the repetition number has not been terminated, moving to the first position of the current bar again and performing repetition playback by repeating the above steps, and, if the repetition number is exhausted, terminating the AR (MR) bar repetition playback.

The above-described AR (MR) bar repetition playback functions to repeatedly play back the current bar of the AR (MR) data when the AR (MR) repetition key is pressed while the song learning system is playing back a selected song.

Since the pressing of the AR (MR) repetition key has been recognized already when the AR (MR) bar repetition playback routine starts, the song currently being played is immediately stopped, and movement to the first position of the current bar of the currently selected AR (MR) song is made.

The AR (MR) data of the current bar is played back. When the AR (MR) data playback of the current bar has been completed, whether a mute pitch insertion value has been set in the mode setting unit 910 is determined.

If the mute pitch value has been set, mute pitches are inserted between bars and bar playback at corresponding lengths using the mode set value set in the mode setting unit 910.

Whether the repetition number has been terminated is determined. If the repetition number has not been terminated, movement to the first position of the current bar is made again, and repetition playback is performed by repeating the above steps. Meanwhile, if the repetition number is exhausted, the AR (MR) bar repetition playback is terminated.

Meanwhile, in another example of the repetition learning method, a user is allowed to freely designate an interval to be repeated, so that the interval designated by the user, rather than a predetermined bar, can be repeatedly played back.

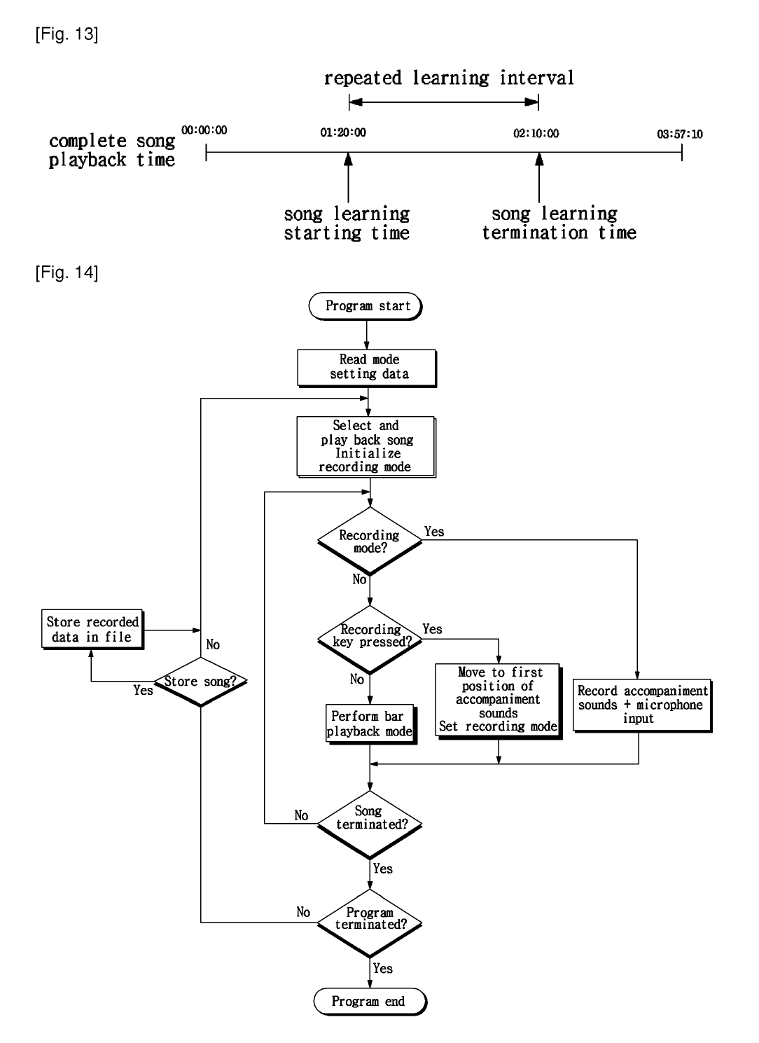

FIG. 13 illustrates the arbitrary interval repetition learning method.

The arbitrary interval repetition learning method includes:

the step of, if the AR (MR) repetition key has been pressed, immediately stopping a song currently being played and determining whether a current location of the currently selected (AR) MR song falls within an interval designated by the user,

the step of, if the current location falls within an interval designated by the user, moving to the first position of the interval designated by the user and playing back AR (MR) data of the current interval, and, if the current location does not fall within an interval designated by the user, moving to the first position of a bar at the current location and playing back the AR (MR) data,

the mute pitch determination step of, if playback of the AR (DR) data of the current bar or current interval is completed, determining whether a mute pitch insertion value has been set in the mode setting unit,

the mute pitch insertion step of, if the mute pitch insertion value has been set, inserting mute pitches between bars and bar playback at corresponding lengths using the mode set value set in the mode setting unit, and

the step of determining whether the repetition number has been terminated, if the repetition number has been terminated, moving to the first position of the current bar or the current interval designated by the user, and performing repetition playback by repeating the above steps, and, if the repetition number has been terminated, terminating the AR (MR) repetition playback.

The bar repetition learning method is a method of when the MR repetition key or AR repetition key is pressed by the user, obtaining the period from the start point of the bar to the end point thereof by calculating the interval of a bar corresponding to the time of the pressing and playing back the part of the MR or AR song corresponding to the obtained interval.

According to this method, there is inconvenience when a user desires to repeatedly practice a specific part existing throughout a plurality of bars.

According to the arbitrary interval repetition learning method, after the user first designates an interval to be repeated, limitless repetition is performed in the current playback mode first. Thereafter, if the MR (AR) repetition key is pressed during the repetition, corresponding MR/AR data is immediately selected, movement to the first position of the designated interval is made, and limitless repetition is performed.

Meanwhile, when the user presses a key for releasing the arbitrary interval repetition mode, the arbitrary interval repetition mode is released, and the current playback is maintained.

FIG. 13 shows the operating interval of the arbitrary interval repetition learning method in a time graph.

It is indicated that the complete playback time for a song is 3 minutes, 57 seconds and 100 milliseconds.

When a user sets the starting time of song learning to 01 minute 20 second and the termination time of song learning to 2 minutes 10 seconds, a repetition learning interval is designated, and limitless repetition playback is performed.

At this time, when the user presses the MR (AR) repetition key, the playback of a file currently being played is stopped, an MR (AR) file is selected, movement to the first position of the designated interval is made, and the designated interval is repeatedly played back.

When the user presses a key for releasing the arbitrary interval repetition mode, the arbitrary interval repetition mode is released, and the current playback is continued.

Furthermore, when recording is selected in the song learning and imitative singing mode, provided accompaniment sounds and the user's voice input through the microphone 700 are created as recorded data, and the recorded data is stored in the recorded data storage unit 300, so that the user can check and play back the recorded data.

Recording is performed at the following steps:

the step of the user selecting accompaniment sounds MR and playing back the selected accompaniment sounds MR,

the mode determination step of initializing the recording mode, and determining whether the recording mode has been currently set by checking the program setting environment values set in the mode setting unit,

the step of, if the recording mode has been set, determining whether a bar-based recording function has been set, if the bar-based setting has been performed, performing the bar-based recording function, and, if the bar-based recording function has not been set, performing complete recording mode,

the step of, if the recording mode has not been set, determining whether a recording key has been pressed, and, if the recording key has been pressed, moving to the starting position of the accompaniment sounds, setting the recording mode, and performing complete recording,

the step of, if the recording key has not been pressed, continuing the bar playback mode,

the step of periodically checking whether the song has been terminated according to a predetermined period, and, if the song has not been terminated, repeating the mode determination step,

the step of, if the song has been terminated, checking whether a program has been terminated, and asking the user whether to store a file that has been recorded in line with the MR accompaniment sounds,

the step of, if the user selects recording, creating and storing the bar-based recorded file as integrated record data in which multiple pieces of bar-based recorded song data are connected to each other, and storing the completely recorded data in a file, and

the step of, if a program termination key has been pressed, terminating the program.

The step of the user selecting accompaniment sounds MR and playing back the selected accompaniment sounds MR, includes, in the case of the accompaniment sounds bar repetition playback:

the step of, if the user selects a recording key, moving to the first position of a corresponding bar and setting recording mode,

the step of recording the current bar,

the step of, if the recording of the current bar has completed, asking the user whether to record current bar recorded data,

the step of, if the user selects storing, storing the recorded data,

the step of determining whether mute pitch insertion has been set in the mode setting unit, and, if the mute pitch insertion has been set, inserting mute intervals according to the set value, and

the step of determining whether the repetition number is exhausted, if the repetition number is exhausted, moving the first position of the current bar again and repeating MR bar repetition, and, if the repetition number has been exhausted, terminating the MR bar repetition recording.

FIG. 14 shows a method in which, in the karaoke system of the present invention, the recording mode is operated in such a manner as to record the complete song at one time.

During recording, an MR repetition or AR repetition function is not operated.

Once a program is started, a program environment setting operation of reading program environment setting data from the mode setting unit 910 and initializing program variables is performed first.

A song selection playback operation in which the user selects a song that the user desires to learn from a song list and plays back the song is performed.

At this time, the recording mode is initialized (mode initialization).

At the subsequent step, whether current recording mode has been set is checked.

If the recording mode has been set, accompaniment sounds+microphone input data are recorded.

If the recording mode has not been set, whether the recording key has been pressed is checked. If the recording key has been pressed, movement to the first of the accompaniment sounds is made and the recording mode is set. If the recording key has not been pressed, bar playback mode is performed.

The bar playback mode is operated in normal playback mode including MR repetition and AR repetition operations.

While the bar playback mode is performed, whether a song has been terminated is periodically checked. If the bar playback mode has not been terminated, the steps starting from the recording mode checking 144 are repeated.

If the one song has been terminated, whether a program has been terminated is checked. If the program has not been terminated, the user is asked whether to store a song that is sung by the user in line with the MR accompaniment sounds in a file in the complete recording mode.

If the storage of the song has been selected, recorded data is stored in a file.

If the program termination key has been pressed, the program has been terminated.

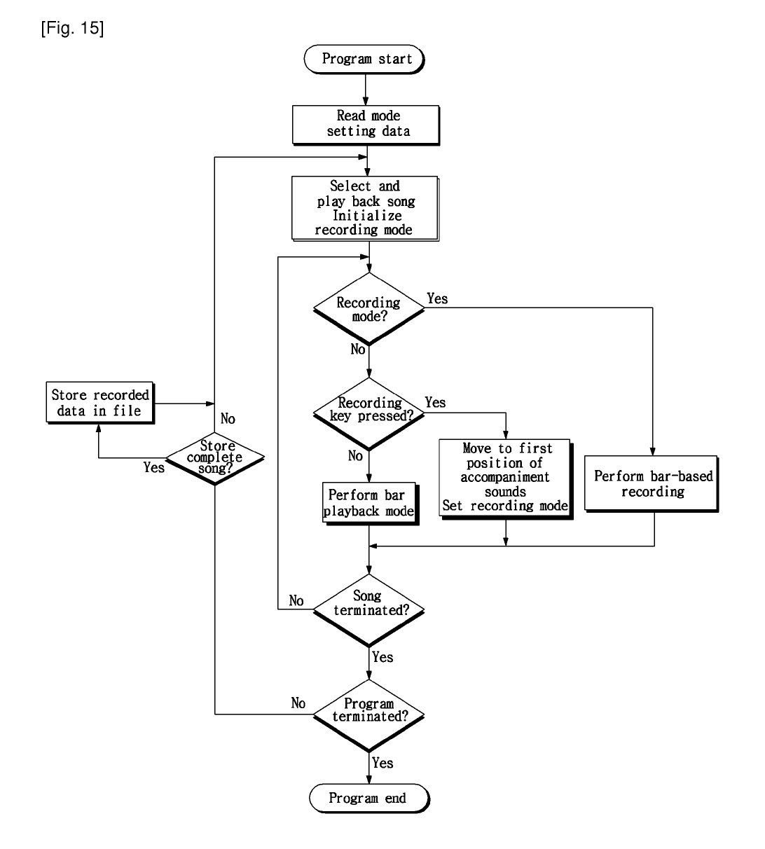

FIG. 15 is an operation flowchart in the case where a bar is selected as a recording unit in the program basic environment settings.

Bar-based recording is a method of, when the user records a song storing and holding recorded data on a per-bar basis and then integrating multiple pieces of stored bar-based recorded data into a single piece of recorded data when the song is terminated.

When multiple pieces of bar-based recorded data are integrated, discontinuous sounds are processed to prevent these sounds from offending general users' ears using one of the existing audio processing methods.

Since the details of the audio processing method deviate from the scope of the present invention, a detailed description thereof is omitted here.

Once a program is started, a program environment setting operation of reading program environment setting data and initializing program variables is performed first.

A part in which the user selects a song that the user desires to learn from a song list and plays back the song is a song selection and playback part.

Here, the recording mode is initialized.

At a subsequent step, whether the recording mode has been currently set is checked.

If the recording mode has been set, a bar-based recording function is performed.

If the recording mode has not been set, whether the recording key has been pressed is checked.

If the recording key has been pressed, movement to the first position of accompaniment sounds MR currently being played is immediately made, and recording mode is set.

If the recording key has not been pressed, the bar playback mode is performed.

The bar playback mode is operated in normal playback mode including MR repetition and AR repetition operations.

While the playback mode is being performed, whether the song has been terminated is periodically checked. If the song has not been terminated, the steps starting from the recording mode checking is repeated.

If the song has been terminated, whether a program has been terminated is checked. If the program has not been terminated, the user is asked whether to record the bar-based song recorded by the user in line with the MR accompaniment sounds, in a file in the complete recording mode.

If the storage of the song is selected, the bar-based recorded song data is stored in a file.

If the program termination key has been pressed, the program has been terminated.

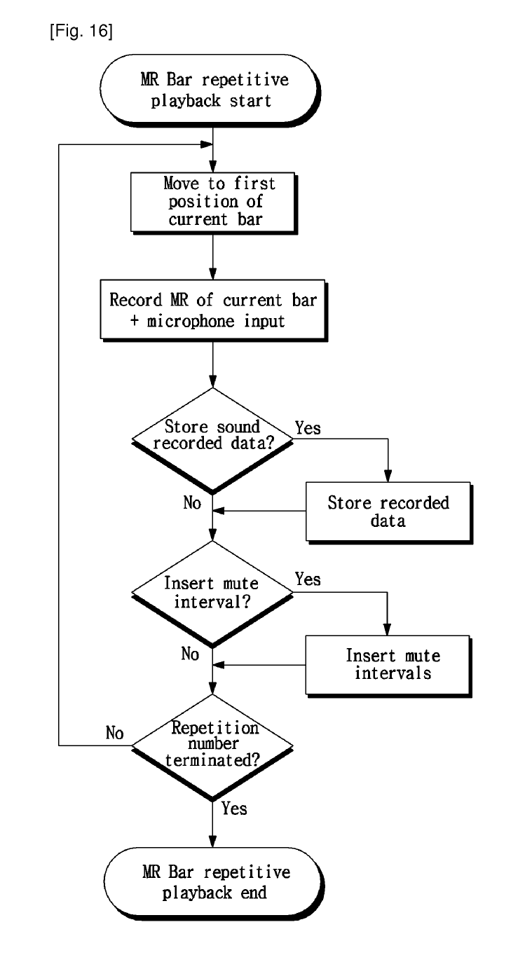

FIG. 16 is a flowchart of the MR bar repetition recording routine.

The MR bar repetition recording routine functions to perform bar-based recording when a recording unit is set to a bar in the mode setting unit 910 and the recording button and the MR repetition key have been pressed.

Once the MR bar repetition recording is started, the playback of a file currently being played is stopped and movement to the first position of the current bar of the MR data is made, since the MR repetition key has been pressed already.

Recording is performed by synthesizing the MR data of the current bar with input from the microphone 700.

If the recording of the current bar has completed, whether to store currently recorded bar recorded data is determined.

If the recorded data is determined to be recorded, the recorded data is stored.

Whether mute pitch insertion has been set in the mode setting unit 910 is determined. If the mute pitch insertion has been set, mute intervals are inserted according to the set value, so that preparation time is given to the user through the insertion of mute intervals between bars during MR bar repetition.

Whether the repetition number has been terminated is determined. If the repetition number has not been terminated, movement to the first position of the current bar is made again and the MR bar repetition recording is repeated. If the repetition number has been terminated, the MR bar repetition recording is terminated.

If the user selects storage when the user determines whether to perform the storage, the previously recorded data corresponding to a current bar is replaced with currently recorded data.

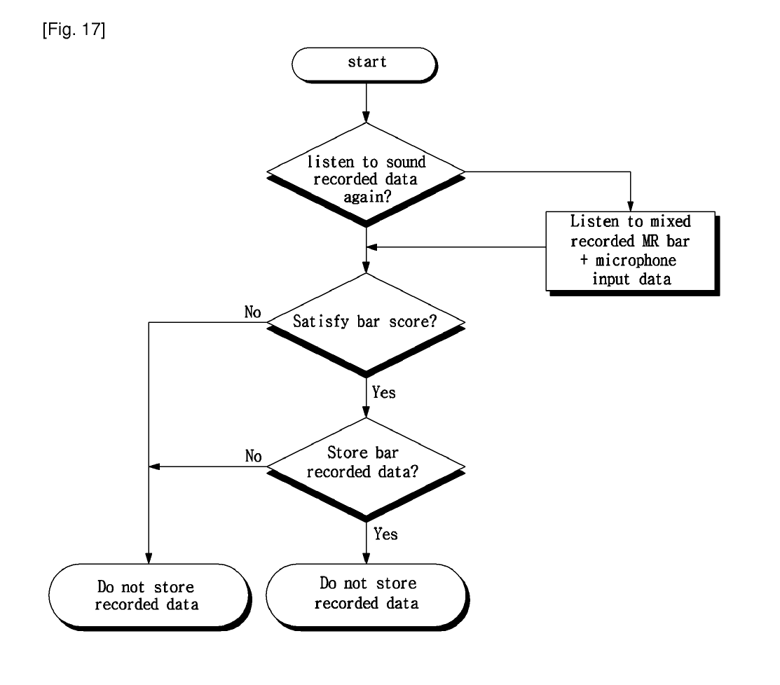

FIG. 17 is a flowchart of a detailed operation for determining whether to record bar-based recorded data.

The user can determine whether to record bar recorded data stored in temporary data memory in the recorded data storage unit 300 on the basis of recorded data listening and evaluation scores.

First, the user is asked whether to listen to the bar recorded data again.

If listening again is selected, recorded accompaniment sounds+microphone input synthesis data is played back.

Thereafter, the user is allowed to make decision by asking the user whether to perform storage.

Alternatively, bar-based evaluation scores are provided, so that the user is allowed to check bar-based evaluation scores and to determine whether to store bar-based recorded data.

Meanwhile, the control unit 900 calculates and displays scores according to environmental setting values set in the mode setting unit 910 by the user.

The song practice control unit 930 displays one or more scores, calculated through the score calculation unit 920, on the display unit 500 through the text display control unit 400.

In this case, the score calculation unit 920 calculates scores for respective bars, and the song practice control unit 930, according to the values set in the mode setting unit 910, performs control so that scores are displayed for respective bars or provides a total score by summing scores for respective bars.

As described above, a song learning score is calculated on the basis of time, the accuracy of pitch and pitch transition similarity, while an imitative singing score is calculated on the basis of time, tone color similarity and tone color transition similarity.

The period of the calculation of scores is dependent on time synchronization information.

The pitch data extraction unit 921 extracts necessary pitch data from pitch data included in content information.

The pitch data extracted as described above is basic pitch data, and forms the input to the pitch accuracy measurement unit 925a and pitch transition similarity measurement unit 925b of the song learning score calculation unit 925.

Furthermore, the first spectrum analysis unit 922 analyzes the user's voice input through the microphone 700, and provides the user's pitch information to the pitch accuracy measurement unit 925a and pitch transition similarity measurement unit 925b of the song learning score calculation unit 925.

Accordingly, the pitch accuracy measurement unit 925a measures similarity by comparing the reference pitch data with the calculated pitch value of the user's voice.

The pitch accuracy measurement unit 925a estimates the pitch of the user's voice using spectrum analysis information obtained by the first spectrum analysis unit 922 for the user's voice input through the microphone 700.

The pitch transition similarity measurement unit 925b measures the similarity between the pitch transition of a song sung by the user, and actual reference pitch transition.

Furthermore, time score measurement unit 925c checks whether the user's voice data has actually been input through the microphone 700 at the time of lyrics letter inversion, and then calculates a time score.

The adder 925d creates an instantaneous score by adding the results of the three comparisons, that is, the outputs of the pitch accuracy measurement unit 925a, the pitch transition similarity measurement unit 925b and the time score measurement unit 925c.

Thereafter, with regard to the instantaneous scores calculated as described above, the score provision unit 925e provides bar-based instantaneous scores or a total score obtained by summing the instantaneous scores and averaging the sum under the control of the song learning control unit.

The imitative singing score calculation unit 926 is operated in such a manner as to compare the spectrum information of a singer's voice and the spectrum information of the user's voice and provide a score proportional to the similarity.

The voice extraction unit 923 extracts only a singer's voice from a singer's song data.

Since typical singer's song data is configured in the form of accompaniment sounds+singer's voice, reference spectrum information should be obtained by extracting only a singer's voice from the singer's song data.

Thereafter, the extracted singer's voice information is input to the second spectrum analysis unit 924, and the second spectrum analysis unit 924 performs spectrum analysis on the singer's voice data extracted by the voice extraction unit 923 and provides the results of the analysis to the tone color similarity measurement unit 926a and the tone color transition similarity measurement unit 926b as reference spectrum information.

The second spectrum analysis unit 924 buffers voice data for a predetermined amount of time, and calculates spectrum information in line with time synchronization information.

The tone color similarity measurement unit 926a measures tone color similarity by comparing the reference spectrum information provided by the second spectrum analysis unit 924 with the spectrum information of the user's voice provided by the first spectrum analysis unit 922.

The tone color transition similarity measurement unit 926b measures the similarity between the amounts of variation of multiple pieces of input spectrum data.

The time score measurement unit 926c checks whether data has actually been input from the microphone 700 at the time of lyrics letter inversion, and calculates a score.

The adder 926d calculates an imitative singing instantaneous score by summing the inputs of the tone color similarity measurement unit 926a, the tone color transition similarity measurement unit 926b and the time score measurement unit 926c.

With regard to the imitative singing instantaneous score calculated as described above, the score provision unit provides, according to the value set through the mode setting unit, imitative singing instantaneous scores created on a per-bar basis, or a total score obtained by summing respective bar-based instantaneous scores, as described in conjunction with the song learning score calculation unit.

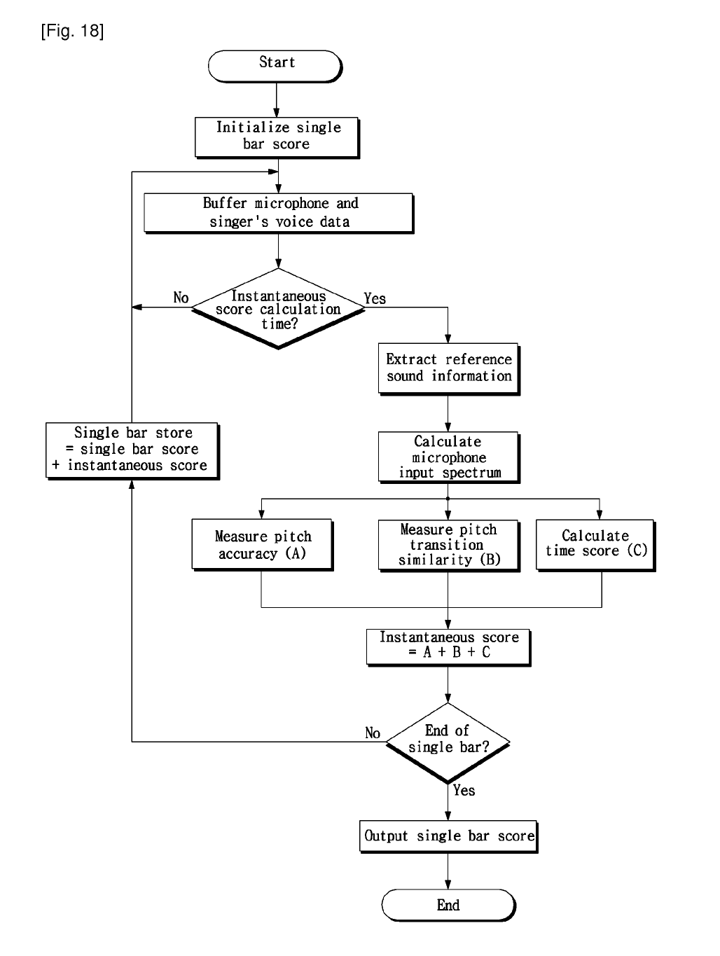

FIG. 18 is a flowchart showing a song learning score calculation process that is performed in song learning mode on a per-bar basis in the present invention.

In order to calculate a bar-based song learning score for each bar, a variable indicative of one bar score is initialized.

Thereafter, whether the time of calculation of an instantaneous score has been reached is checked on the basis of the time synchronization information.

If the calculation time has not been reached, the microphone and singer's voice data are repeatedly buffered.

If the calculation time has been reached, reference pitch information corresponding to current time is extracted and the spectrum of the user's audio input through the microphone is calculated.

The pitch of the user's input voice is measured using the user's voice input spectrum, and the accuracy of the pitch is measured by comparing the user's voice input spectrum with a reference pitch value.

Furthermore, the extent of similarity is measured by comparing the transition of the reference pitch information with the pitch information transition of the microphone input signals.

Furthermore, a time score is calculated for a predetermined amount of time (instantaneous score calculation period).

An instantaneous score is calculated by summing the three measurement values A, B and C obtained as described above.

Thereafter, whether the last position of the bar has been reached is determined.

If the last position has not been reached, a new bar score can be obtained by adding a currently obtained instantaneous score to a current bar score.

If the last position of the corresponding bar has been reached because the time corresponding to the bar has elapsed, a currently calculated bar score is output.

In this case, a song learning score may be calculated using only one or two values selected from the three measurement values when necessary.

Accordingly, in the case where all the three values cannot be utilized due to the limited performance of an implementation system, the values may be selectively utilized.

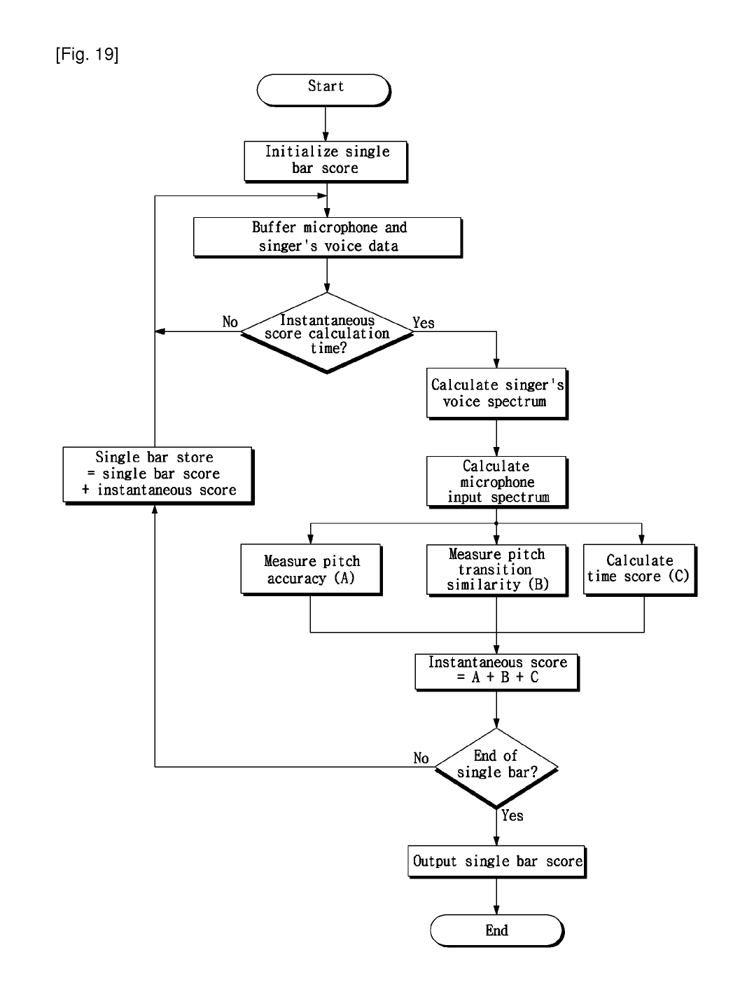

FIG. 19 is a flowchart showing the calculation of an imitative singing score.

Imitative singing scores are calculated and used for respective bars of a song.

In order to calculate bar-based imitative singing scores for respective bars, a variable indicative of a bar score is initialized.

Thereafter, whether the time of calculation of an instantaneous score has been reached is checked on the basis of the time synchronization information.

If the calculation time has not been reached, the microphone and singer's voice data is continuously buffered.

If the calculation time has been reached, the spectrum of the singer's voice and the spectrum of microphone input audio are calculated.

A tone color similarity measurement value and a tone color transition similarity measurement value between the two spectra are obtained as described above.

Furthermore, a time score is calculated for a predetermined period (an instantaneous score calculation period).

An instantaneous score is calculated by summing the three measurement values obtained as described above.

Thereafter, whether the last position of a bar has been reached is determined.

If the last position of the bar has not been reached, a bar score may be obtained by adding a currently obtained instantaneous score to a current bar score.

If the last position of the bar has been reached because the time corresponding to the bar has elapsed, a currently calculated bar score is output.

In this case, it is possible to implement the present invention using only one or two values selected from among the above-described three measurement values when necessary. In the case where all the three values cannot be utilized due to the limited performance of an implementation system, it is possible to selectively utilize the values.

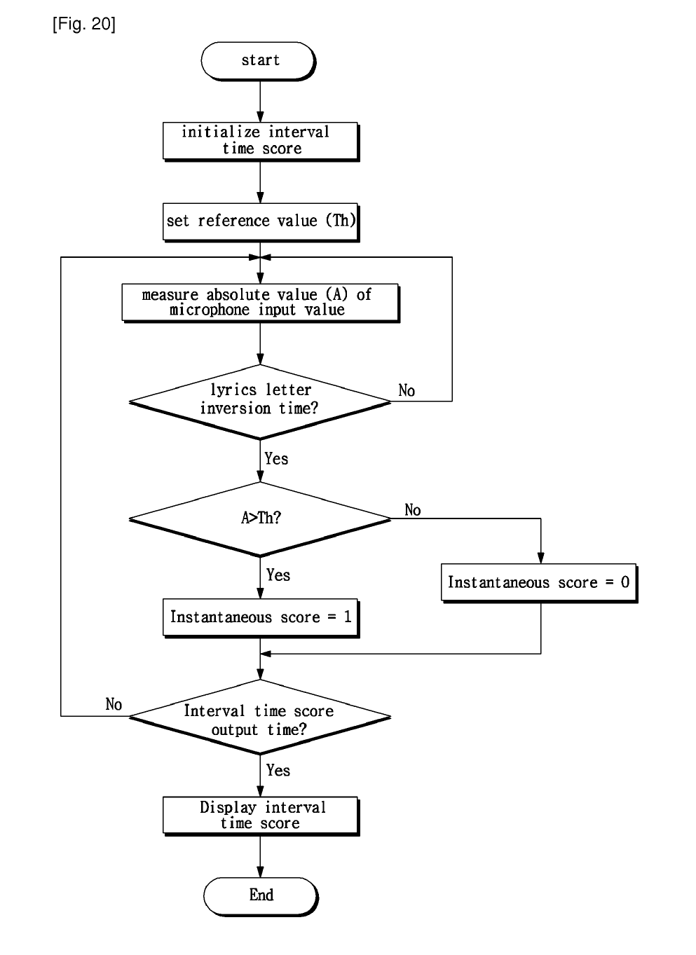

FIG. 20 is a flowchart showing a process of calculating time scores in predetermined intervals.

An interval time score variable value is initialized to 0.

Furthermore, a reference value Th for determining whether there is voice input to the microphone is determined.

A value that is greater than a microphone input value without voice A and less than a microphone input value with voice is appropriately set as the reference value.

Thereafter, the absolute value of the microphone input value is measured and then stored.

Whether the time of lyrics letter inversion has been reached is checked. If the time of lyrics letter inversion has not been reached, the microphone input value is continuously monitored.

If the time of lyrics letter inversion has been reached, whether the microphone input value A obtained above is greater than voice input determination reference value Th is determined.

If the microphone input value A is greater than the reference value Th, 1 is substituted for the instantaneous score. In contrast, if the microphone input value A is equal to or less than the reference value, 0 is substituted for the instantaneous score.

Whether the time of interval time score output has been reached is determined.

If the time of interval time score output has not been reached, instantaneous time scores are accumulated in the interval time score.

If the time of interval time score output has been reached, a score obtained by dividing a current interval time score by the number of lyrics letter inversions in a current interval is given as a percentage.

That is, a percentage score indicative of the proportion of the number of accurate microphone inputs to the total number of time measurements can be obtained.

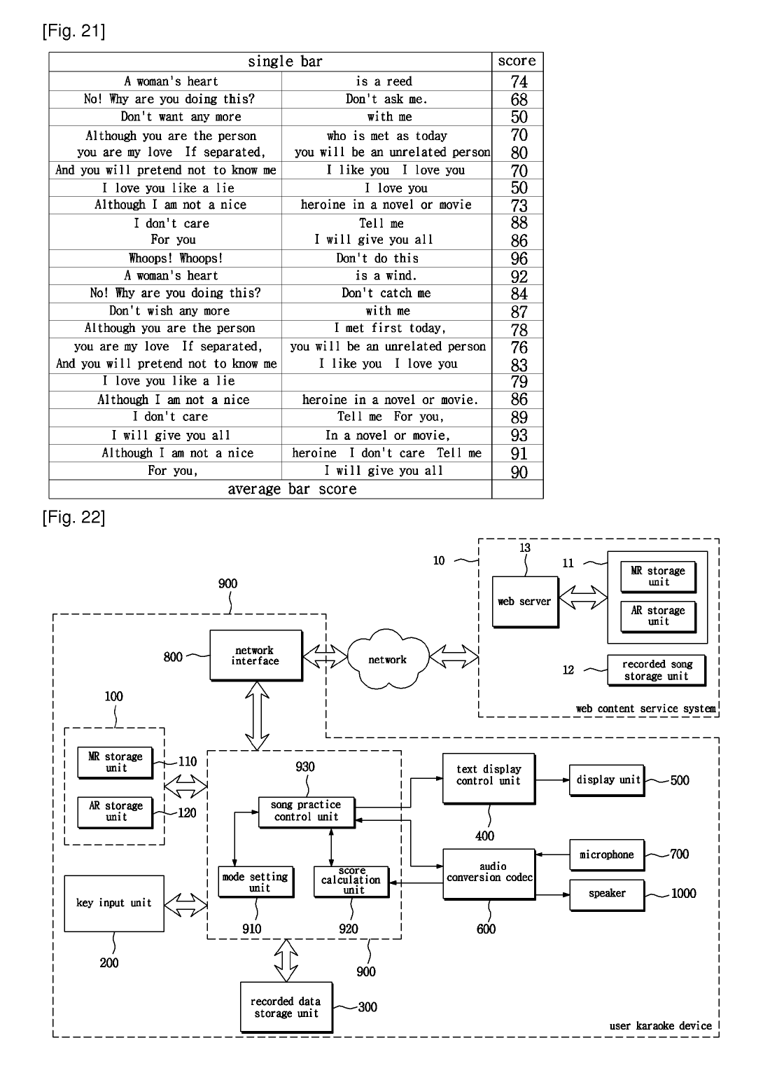

FIG. 21 shows an example of displaying bar-based scores for bars, sung using MR, when a complete song is terminated.

A user may determine which bars have been sung incorrectly while viewing the bar scores shown in this drawing. When the user selects a specific bar, immediate movement to the selected bar may be made through a link connection to corresponding bar data and the bar may be practiced.

Moreover, since an average bar score is given, the user can check an evaluation score for the complete song.

Meanwhile, FIG. 22 shows a second embodiment of the present invention. This embodiment is configured in such as manner as to construct accompaniment sound and singers' song content data at a remote web server accessed over a network; rather than constructing it in the form of local data, and be provided with content data by the remote web server.

The second embodiment includes a key input unit 200 for enabling a user to press keys related to the selection of songs and the control of playback/recording, a recorded data storage unit 300 for storing the user's singing data during the user's song practice, a text display control unit 400 for processing text captions, such as lyrics captions and scores, for display means, a display unit 500 for displaying lyrics, scores and screens for song practice, an audio conversion codec 600 for converting digital signals into analog signals so as to output the accompaniment sounds and the singers' songs stored in local data content storage means 100 or converting the user's voice analog signals input through a microphone 700 into digital signals, the microphone 700 for converting the user's voice into electrical signals, a network interface 800 for connecting to a network and receiving content data from a web server, a control unit 900 for providing accompaniment sounds or a singer's song according to the user's selection and providing a series of control processes related to playback/recording for the user's song practice, a speaker 1000, and the local data storage unit 100 for storing data downloaded from a web service system and processed in the user karaoke device; and

a web content service system 1 for providing the accompaniment sound or singers' song content data to the user karaoke device over a network;

wherein the web content service system 1 includes a content storage unit la for storing accompaniment sound (MR) and singers' song (AR) data for song practice, a recorded song storage unit 1b for registering and storing song data recorded through the user karaoke device and uploaded by the user, and a server 1c for supporting connection to the user karaoke device, the provision of accompaniment sound or singers' song content to the connected user karaoke device, the upload storage of recorded song data, and a playback control process.

The above-described second embodiment of the present invention is an embodiment for receiving accompaniment sounds or singers' songs from the web server 1c, rather than from the local system like the first embodiment, over the web and operating the user karaoke device.

It is apparent that the first embodiment of the present invention may connect to the web content service system 10 through the network interface 800, receive new accompaniment sound and singers' song content, store it in the content storage unit 100, and locally operate the content storage unit 100.

The content data stored in the content storage unit 11 may be provided in the form of a new integrated file in which two pieces of data, that is, accompaniment sound data and a singer's song data, have been integrated into a single file, so as to increase the efficiency of content service, storage and management, as shown in FIG. 2.

In another embodiment of the present invention, the song practice system of the present invention may be applied to portable terminals, such as a car navigation system, an MP3 player, a PDA, a Portable Multimedia Player (PMP) and a mobile phone, to which song accompaniment systems have been applied.

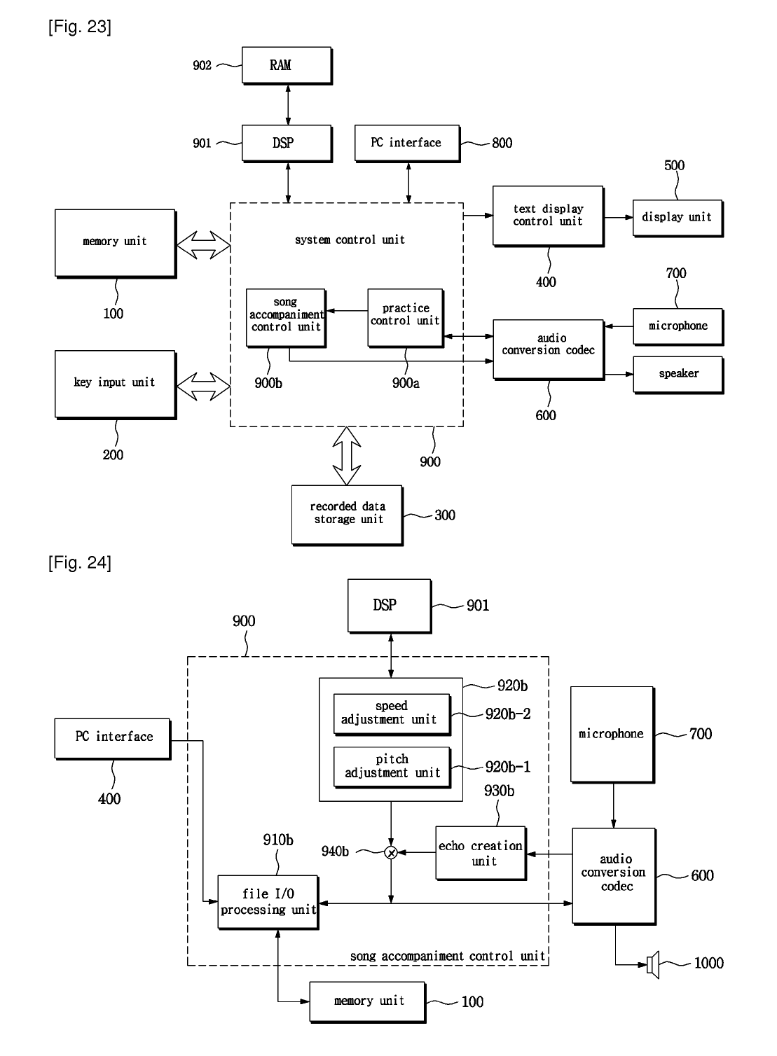

FIG. 23 is a block diagram showing a construction in which the song practice system of the present invention is applied to a digital sound player to which song accompaniment means have been applied.

The digital sound player includes:

a memory unit 100 for storing a control program, song accompaniment data, and accompaniment sound (MR) and singers' song (AR) data for song practice,

a key input unit 200 for enabling key input related to the selection of songs for sound playback and song practice, the control of playback/recording, and pitch, speed and echo adjustment for song accompaniment,

a recorded data storage unit 300 for storing a user's song data during the user's song practice,

a text display control unit 400 for processing text captions, such as lyrics captions and scores, for a display unit 500,

the display unit 500 for displaying lyrics, scores and screens for song practice,

an audio conversion codec 600 for converting digital signals into analog signals so as to play back and output digital data or converting the user's voice analog signals input through a microphone 700 into digital signals,

the microphone 700 for converting the user's voice into electrical signals,

a PC interface 800 for connecting to a PC,

a system control unit 900 including a practice control unit 900a for controlling a series of processes for digital playback control, providing accompaniment sounds or a singer's song according to the user's selection, and providing a series of control processes related to playback/recording for the user's song practice, and a song accompaniment control unit 900b for providing processes for pitch and speed control for song accompaniment, echo adjustment and song accompaniment control,

a digital signal processor DSP (901) for providing a process for playing back multimedia sounds or moving images, and

RAM, that is, a memory device, for performing digital signal processing.

The practice control unit 900a includes:

a mode setting unit 910a for providing a process of setting the operating mode for song practice and storing the operating mode selected by the user, a score calculation unit 920b for calculating a score for the user's practice results during song practice, and a song practice control unit 930a for controlling the playback/recording of accompaniment sounds or singers' songs stored in the memory unit 100 according to the environmental setting values set in the mode setting unit 910a.

The song accompaniment control unit 900b includes:

a file input/output processing unit 910b for storing audio data, in which song accompaniment sounds are mixed with the user's voice input through a microphone, in a recorded data storage unit 300, uploading audio data stored in the recorded data storage unit 300 to a PC through the PC interface 800, or storing one or more files downloaded from the PC in the memory unit 100, a pitch/speed adjustment unit 920b for adjusting a pitch and playback speed using PCM data in which digital sounds have been decoded to the extent desired by the user, an echo creation unit 930b for performing feedback so as to apply an echo effect to microphone input audio signals, and a mixer 940b for mixing the user's voice signals, input through the microphone 700, with accompaniment data, input through the pitch/speed adjustment unit 920b, and outputting resulting data to the audio conversion codec 600 or file input/output processing unit 910b.

The above-described embodiment of the present invention is constructed by applying the song practice system to a digital sound player capable of receiving song accompaniment content from a content provider and playing back the content (for example, a player capable of playing back digital sounds, such as an MP3 player, a Windows Media player, Winamp, or a media player).

The present invention has technical characteristics in that in order to implement functions almost identical to those of an offline karaoke parlor in a portable terminal, a portable or car digital sound player or a digital sound karaoke system using a mobile phone in which pitch variation, speed variation and echo functions are implemented using digital source sound music accompaniment sounds is provided, and song practice is enabled in such a song accompaniment system.

The present embodiment is configured to include practice control means for controlling song practice and song accompaniment control means in the system control unit 900 of the digital sound player. The present embodiment is characterized in that it provides a song accompaniment function such as pitch and speed adjustment and echo creation through the song accompaniment control unit 900b, a song practice function through the practice control unit 900a, and the song accompaniment function in a song practice process through the song accompaniment control unit 900b in connection with song accompaniment.

The practice control unit 900a has the same construction as those of the first and second embodiments of the present invention, and a detailed description thereof will be omitted here.

FIG. 24 is a block diagram showing the detailed construction of the song accompaniment control unit according to an embodiment of the present invention embodiment.

The file input/output processing unit 910b is means for storing audio data, in which song accompaniment sounds are mixed with the user's voice input through a microphone, in the memory unit 100, uploading audio data stored in the memory unit 100 to a PC through the Pc interface 800, or storing one or more files downloaded from the PC in the memory unit 100

The file input/output processing unit 910b is means for enabling the storage of audio data generated during song practice in the memory unit 100, the upload of the audio data to a PC through the Pc interface 800 so that it is transferred to the server of a service system for providing content data, or the reception of content data (song accompaniment data) from the server of a service system through a PC.

The pitch/speed adjustment unit 920b is means for adjusting a pitch and playback speed using audio data in which digital sounds have been decoded to the extent desired by the user.

The echo creation unit 930b is means for applying an echo effect to the user's voice by feeding back audio signals input through the microphone 700.

The mixer 940b is means for mixing the user's voice signals, input through the microphone 700, with accompaniment data, input through the pitch/speed adjustment unit 920b.

Here, as described above, the microphone 700 is not an essential element, and the microphone input unit and the echo creation unit need not be used. Furthermore, only the microphone input terminal may be provided, and an external microphone may be employed, in which case a microphone having an echo function may be used instead of the echo creation unit 930b.

The operation of the digital sound player constructed as described above will be described below.

As the user selects a desired song and performs mode setting (the selection of operating mode and a function) through the key input unit 200, the system control unit 900 provides accompaniment sound or singers' song data through the memory unit 100.

At this time, the system control unit 900 displays the lyrics of a song being played on the display unit 500 through the text display control unit 400 in text form, thereby enabling the user to view the lyrics and sing or learn the song.

The operating mode may be divided into general playback mode and practice mode. In the general playback mode, the user can perform control related to song accompaniment, such as pitch and speed control and echo setting. The practice mode may be divided into song learning mode and imitative singing mode, as described in the embodiment.

In actual song practice mode, the song accompaniment function, such as pitch and speed control and echo setting are basically prevented from being controlled because the purpose of the mode is song practice. Alternatively, the user may select the performance of the function through the mode setting unit 910.

Accordingly, the mode setting unit 910 may include song accompaniment function on/off setting mode.

Since the song learning mode and the imitative singing mode operate in the same manner as in the above embodiment, a description of the operations is omitted here.

The user selects a song and performs a song accompaniment function, such as desired pitch and speed adjustment and echo setting.

The operations of the pitch and speed adjustment and echo setting will be described in detail below.

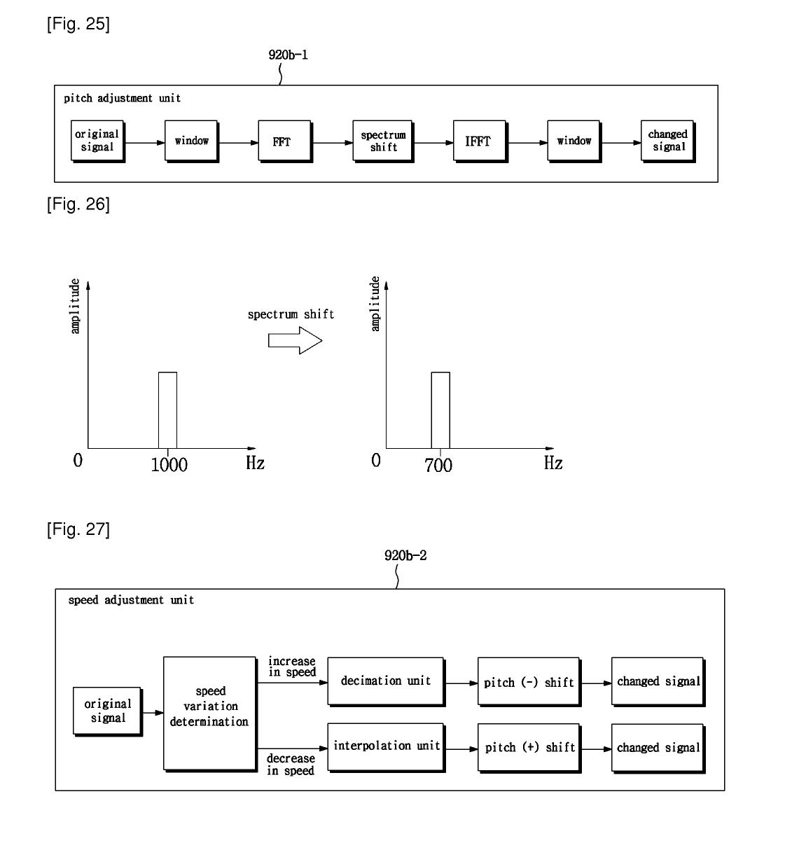

FIG. 25 is a block diagram showing the construction of a pitch adjustment unit 920b-1.

As shown in this drawing the pitch adjustment unit includes a window for dividing an original signal into signals at short intervals in the time plane, a Fourier transform unit FFT for performing Fourier transform on the signals at short intervals, a spectrum shift for shifting an amplitude spectrum obtained by the Fourier transform unit to the extent desired by the user, an inverse Fourier transform unit IFFT for performing inverse Fourier transform on the spectrum-shifted signals, and a window for outputting signals changed through filtering so as to eliminate inconsistency between frames.

According to the principle, processing is performed using Short Time Fourier Transform (STFT) on the assumption that an audio signal to be processed is stationary at a short interval. That is, it may be assumed that although an audio signal is non-stationary in a wide range, a signal is stationary at a short interval (several tens of msec) (it is assumed that statistical characteristics (average, variance, or the like) are constant over time). The STFT may be used to analyze a signal, the phase or frequency component of which varies with time.

The original signal refers to an audio signal that should be processed so as to adjust the pitch.

The window is used to divide time plane data into short intervals. Furthermore, the window functions to attenuate a phenomenon in which a frequency spectrum is spread when a change to the frequency spectrum is made (Gibbs phenomenon).

In order to realize transform to a frequency plane signal, the Fourier transform unit FFT performs Fourier transform.

At this time, an amplitude spectrum can be obtained.

The spectrum shift shifts the amplitude spectrum obtained by the Fourier transform unit to the extent desired by the user

FIG. 26 shows an example of spectrum shift.

An example in which the size of an amplitude spectrum is not varied and only a frequency band is shifted from 1000 Hz to 700 Hz is given.

A time axis signal is created by performing inverse transform IFFT 206 using the shifted spectrum. In order to eliminate abrupt inconsistency between neighboring frames, window processing 207 is performed and then an audio signal 107, the complete pitch of which has been shifted, is created.

FIG. 27 is a diagram showing a speed adjustment unit 920b-2 according to the present invention.

The speed adjustment unit 920-b is a unit for varying the speed of playback of song accompaniment sounds and preventing the variation in pitch even though the speed of playback is varied.

The speed adjustment unit 920-b includes a speed variation determination unit for, when an unvaried original signal is input, determining variation in speed of the input signal, a decimation unit for in the case of increase in speed, eliminating portions of the original signal, an interpolation unit for in the case of decrease in speed, inserting data samples into the original signal, a pitch (−) shift unit for outputting a signal varied by reducing a pitch so as to correct the pitch of a signal output from the decimation unit, and a pitch (+) shift unit for outputting a signal varied by increasing a pitch so as to correct the pitch of a signal output from the interpolation unit.

In the case where an unvaried original signal is input and the speed of the input signal is increased, when a decimation process of removing portions from the original signal is performed, and then data is transmitted to a DAC at a speed identical to that of the original signal and output through the speaker, the speed of playback of sounds is reduced.

Here, when sounds are accelerated, the pitch is increased. In order to correct this, processing is performed so as to reduce the pitch.

If, when the speed of playback is desired to be reduced, an interpolation process of inserting data samples into the original signal is performed, resulting data is transferred to a digital analog converter (DAC) at the same sampling speed and a signal is output, the reduction in the speed of playback can be sensed.

At this time, the pitch is also reduced. In order to correct this, positive (+) pitch shift is performed.

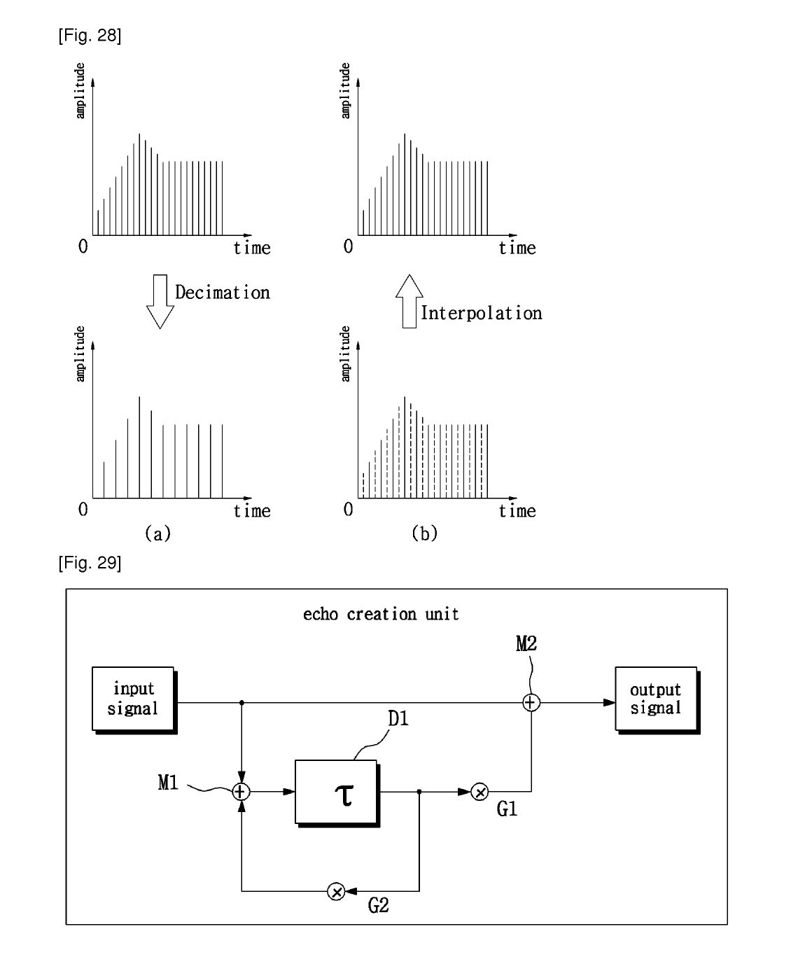

Illustrations of the decimation and interpolation used in this embodiment are given in FIG. 28.

A process of taking portions of an original signal at regular intervals is referred to as decimation, as illustrated in FIG. 28(a).

Furthermore, a process of periodically inserting data into an original signal at a predetermined ratio is referred to as interpolation, as illustrated in FIG. 28(b).

From the drawing it can be seen that data has been increased twice.

The echo creation unit 930b is a unit for applying an echo effect to a microphone input signal, as in an offline karaoke parlor.

Although in the case of a typical offline karaoke parlor, the application of an echo effect is implemented using a hardware chip, the application is implemented in a software manner in the present embodiment.

FIG. 29 is a block diagram showing the functions of the echo creation unit 930b according to the present invention.

The echo creation unit includes a first adder M1 for synthesizing an input signal with a delayed feedback signal, a delayer D1 for delaying the output signal of the first adder M1 by a predetermined time τ msec, a reverberation time adjuster G2 for feeding back the output signal of the delayer D1 to the first adder M1, and adjusting reverberation time using the level of resistance thereof a reverberation intensity adjuster G1 for adjusting reverberation intensity by adjusting the intensity of the output signal of the delayer D1, and a second adder M2 for outputting an echo-controlled signal by synthesizing the output signal of the reverberation intensity adjuster G1 with the input signal.

In the echo creation unit 930b, the reverberation time is long when the reverberation adjuster G2 is large, and the reverberation time is short when the reverberation adjuster G1 is small.

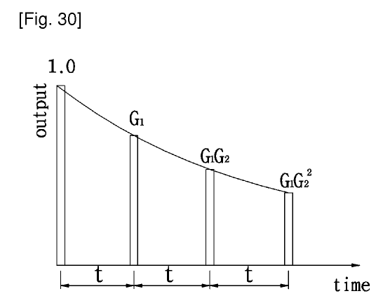

Furthermore, the intensity of reverberation can be adjusted using the value of the reverberation adjuster G1. FIG. 30 shows the output signal of the echo creation unit 930b.

When pulses having a magnitude of 1 are applied to the input, the pulses are delayed by τ msec and are regularly attenuated.

The echo creation unit 930b is implemented using the combination of a delay element and a feedback loop, as described above.

The above-described present invention may be applied to a mobile phone and a car navigation system, including digital sound players or digital sound playback means.

When the present invention is applied to a mobile phone, it is possible to connect to the server of a content data service system for providing content data, such as song accompaniment data, using the wireless communication function of the mobile phone, and to be provided with content data or upload the user's recorded audio data.

Furthermore, it is possible to provide a wired/wireless network connection interface means in a digital sound player having the above-described system, connect to a specific network and connect to the server of the above-described content data service system.

When the present invention is applied to a mobile phone, the user can use an accompaniment function of enabling a user to sing a song with accompaniment during a call as needed, perform song practice together, and provide the functions to a counter party.

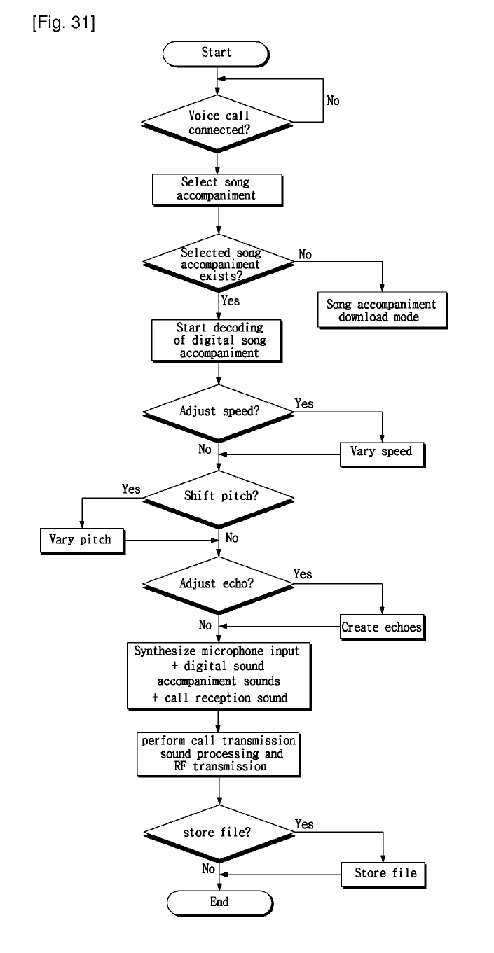

FIG. 31 is a flowchart showing the control of a karaoke function during a call in an embodiment of the present invention in which the song accompaniment and song practice system of the present invention is applied to a mobile phone.

That is, the drawing illustrates a function in which, when one between two voice calling parties or among multiple voice calling parties sings a song with the song accompaniment system, the calling users can listen to audio data in which corresponding song accompaniment sounds and the user's voice have been added.

The drawing illustrates a system in which, in the case where the user of a mobile communication terminal A sings a song with digital accompaniment sounds stored in memory while the user having the mobile communication terminal A makes calls with a mobile communication terminals B and C at the same time, corresponding synthesis voice data is transferred to the users of the mobile communication terminal A and C via a base station.

At a first step of determining whether a call connection is established between mobile phones, whether a call has been connected is determined.

When a karaoke function and song accompaniment are selected during the establishment of a call if the voice call has been established, a second step of searching the memory of the mobile phone for digital sound song accompaniment for the selected song accompaniment is performed.

When the song accompaniment mode is selected and then song accompaniment is selected, whether digital sound song accompaniment content exists in the current mobile phone terminal is checked.

If the digital sound song accompaniment content does not exist, corresponding content can be downloaded over the wired/wireless Internet according to the user's selection.

Thereafter, if the song accompaniment selected at the second step is found, a third step of decoding and then playing back the corresponding digital sound song accompaniment is performed. If the user request speed adjustment during the playback of the song accompaniment, a speed variation function is performed.

If the user desires pitch variation, the pitch variation is performed.

Furthermore, if the user desires echo adjustment, echoes are created in a microphone input voice signal.

Thereafter, a fourth step of synthesizing the microphone input signal input while the song accompaniment is being played back at the third step or a call reception sound received from another mobile phone during a call connection with the digital accompaniment sounds and outputting a resulting signal through the speaker is performed, and

a fifth step of converting the song accompaniment and voice audio signal at the fourth step into a call transmission signal for mobile phone wireless transmission and RF-transmitting the call transmission signal in the form of a mobile phone voice transmission signal is performed.

That is, the microphone input signal, the digital accompaniment sounds and the call reception signal are synthesized together and are output through the speaker, and the resulting audio signal is converted into a call transmission signal and is wirelessly transmitted via an RF stage.

At the same time, a song sung by the user may be stored in a file.

If the user selects a file storage mode, the resulting audio signal is stored in memory in a file.

The stored data may be stored and held in the server of a system for providing content data over a wireless data network.

Meanwhile, according to speed increase/decrease input, the speed adjustment is performed through speed adjustment mode of, in the case of increase in speed, performing a decimation process of removing sounds of the amplitude signal of digital sound accompaniment, and creating an accelerated song accompaniment signal by reducing the pitch thereof so as to correspond to a reduced signal, and, in the case of reduction in speed, performing an interpolation process of inserting sample sounds into the amplitude signal of the digital sound accompaniment, and creating a song accompaniment signal by increasing the pitch thereof so as to correspond to an increased signal.

Furthermore, when a pitch adjustment signal is input, a pitch adjustment mode, including a step of converting an original signal into a frequency spectrum using a window for dividing the original signal into short intervals in the time plane; a step of acquiring an amplitude spectrum signal by Fourier-transforming the resulting frequency spectrum;

a step of shifting only a frequency band in response to a pitch adjustment input without varying the magnitude of the amplitude spectrum signal; a step of restoring the amplitude spectrum signal, the frequency band of which has been shifted, into a time axis frequency spectrum signal by performing inverse Fourier transform on the amplitude spectrum signal; and a step of creating an audio signal, the complete pitch thereof has been shifted, by performing window processing so as to eliminate the inconsistency between the neighboring frames of the restored signal, is performed.

Furthermore, when echo adjustment mode is selected and an echo adjustment signal is input, echo adjustment mode, including a step of synthesizing a microphone input signal with a feedback signal; a step of delaying the synthesized signal by a predetermined time; a step of adjusting the intensity of echoes for the delayed signal and feeding back the resulting signal to the synthesis step as the feedback signal; a step of adjusting the intensity of the echoes for the delayed signal; and a step of synthesizing the microphone input signal with the signal, the intensity of the echoes has been adjusted, and inputting a microphone input signal including echoes as the microphone input signal of the fourth step, is performed.

According to the above-described present invention embodiment, a song accompaniment system and song practice system using digital source sounds can be implemented.

### INDUSTRIAL APPLICABILITY

According to the present invention, bar-based repetitive practice can be performed alternately using a singer's song and accompaniment sounds according to the user's necessity, and effective song learning can be performed according to the user's purpose such as song education or imitative singing practice, so that there is an advantage in that the user can easily learn songs, particularly a new song.

The user can easily determine weak portions because bar-based scores can be calculated and the degree of the user's song learning can be objectively determined through complete or bar-based recording based on the recording function, thereby increasing the user's interest.

Moreover, the user can selectively perform bar-based recording, and recorded partial songs are enabled to be integrated into a single complete song thereby increasing the user's interest.

1. A karaoke system having a song learning function, comprising:
content storage means for storing content data including accompaniment sound (MR) and singers' song (AR) data for song practice;
input means for enabling a user to input user control values related to selection of songs and control of playback/recording;
recorded data storage means for storing the user's singing data during the user's song practice;
text display control means for processing text captions, such as lyrics captions and scores;
display means for displaying lyrics, scores and screens processed by the text display control means for song practice;
an audio conversion codec for converting digital signals into analog signals so as to output the accompaniment sounds and the singers' songs stored in the content storage means or converting the user's voice analog signals input through a microphone into digital signals;
the microphone for converting the user's voice into electrical signals;
a network interface for connecting to a predetermined network; and
control means for providing accompaniment sounds or a singer's song according to the user's selection and providing a series of control processes related to playback/recording for the user's song practice.

2. A karaoke system having a song learning function, comprising:
a user karaoke device comprising:
a user control value input unit for enabling input of user control values related to selection of songs and control of playback/recording;
a recorded data storage unit for storing the user's singing data during the user's song practice;
a text display control unit for processing text captions, such as lyrics captions and scores;
a display unit for displaying lyrics, scores and screens for song practice;
an audio conversion codec for converting digital signals into analog signals so as to output the accompaniment sounds and the singers' songs stored in local data content storage means or converting the user's voice analog signals input through a microphone into digital signals;
the microphone for converting the user's voice into electrical signals;
a network interface for connecting to a network and receiving content data from a web server;
control means for providing accompaniment sounds or a singer's song according to the user's selection and providing a series of control processes related to playback/recording for the user's song practice;
a speaker; and
local data storage means for storing data downloaded from a web service system and processed in the user karaoke device; and
a web content service system for providing the accompaniment sound or singers' song content data to the user karaoke device over a network, wherein the web content service system comprises:
content storage means for storing accompaniment sound (MR) and singers' song (AR) data for song practice;
recorded song storage means for registering and storing song data recorded through the user karaoke device and uploaded by the user; and
a server for supporting connection to the user karaoke device, provision of accompaniment sound or singers' song content to the connected user karaoke device, upload storage of recorded song data, and a playback control process.

3. A karaoke system having a song learning function, comprising:
content storage means for storing accompaniment sound (MR) and singers' song (AR) data for song practice;
input means for enabling a user to input user control values related to selection of songs and control of playback/recording;
text display control means for processing text captions for display means;
display means for displaying lyrics and screens for song practice;
audio conversion means for converting digital signals into analog signals so as to output the accompaniment sounds and the singers' songs stored in the content storage means;
a network interface for connecting to a predetermined network; and
control means for providing accompaniment sounds or a singer's song according to the user's selection and providing a series of control processes related to playback for the user's song practice.

4. The karaoke system according to claim 3, further comprising a microphone input terminal, a microphone configured to be connected to the microphone input terminal, and audio conversion means configured to convert the user's analog voice signals, input through the microphone connected to the microphone input terminal, into digital signals.

5. The karaoke system according to claim 4, further comprising recorded data storage means for storing the user's song data during the user's song practice.

6. The karaoke system according to claim 1, wherein the control means comprises:
a mode setting unit for providing a process for setting operating mode for song practice and storing operating mode selected by the user;
a score calculation unit for calculating a score for the results of the user's practice during the user's song practice; and
a song practice control unit for controlling playback/recording of accompaniment sounds or singers' songs stored in the content storage unit according to an environmental setting value set in the mode setting unit.

7. The karaoke system according to claim 1, wherein the control means further comprises song accompaniment control means for controlling a series of processes for control of digital playback, providing accompaniment sounds or singers' songs according to the user's selection, and providing a process for adjustment of a pitch and speed of song accompaniment, echo setting and song accompaniment control.

8. The karaoke system according to claim 6, wherein the score calculation unit comprises:
a pitch data extraction unit for extracting reference pitch information from musical pitch information contained in content data provided in advance by a content provider in line with accompaniment sounds on a basis of time synchronization information calculated from caption time information for display of lyrics captions contained in accompaniment sounds data by the song practice control unit;
a first spectrum analysis unit for analyzing a spectrum of the user's voice input through the microphone on a basis of the time synchronization information;
a voice extraction unit for extracting the singer's voice data from the singer's song data;
a second spectrum analysis unit for analyzing a spectrum of the voice extracted by the voice extraction unit;
a song learning score calculation unit for receiving reference pitch information from the pitch data extraction unit, comparing the reference pitch information with user pitch information acquired through the analysis by the first spectrum analysis unit, acquiring time from lyrics inversion information, and calculating a song learning score, and
an imitative singing score calculation unit for comparing reference spectrum information acquired through the analysis of the singer's song data by the second spectrum analysis unit with the user's tone color acquired through the spectrum analysis of the user's voice by the first spectrum analysis unit, detecting the time from the lyrics inversion information, and calculating an imitative singing score.

9. The karaoke system according to claim 6, wherein the score calculation unit comprises a song learning score calculation unit for detecting time from the user's voice input through the microphone and lyrics inversion information and then calculating a song learning score.

10. The karaoke system according to claim 1, wherein the content data stored in the content storage means further comprises a singer's song spectrum information.

11. The karaoke system according to claim 8, wherein the score calculation unit comprises:
a pitch data extraction unit for extracting spectrum information registered in a singer's song content data in advance by a content provider on the basis of time synchronization information calculated from caption time information for display of lyrics captions contained in accompaniment sounds data by the song practice control unit;
a first spectrum analysis unit for analyzing a spectrum of the user's voice input through the microphone on a basis of the time synchronization information;
a voice extraction unit for extracting the singer's voice data from the singer's song data;
a second spectrum analysis unit for analyzing a spectrum of the voice extracted by the voice extraction unit;
a song learning score calculation unit for receiving reference pitch information from the pitch data extraction unit, performing comparison with user pitch information acquired through the analysis by the first spectrum analysis unit, detecting time from lyrics inversion information, and calculating a song learning score; and
an imitative singing score calculation unit for comparing reference spectrum information obtained through the analysis of the singer's song data by the second spectrum analysis unit with the user's tone color obtained through the spectrum analysis of the user's voice by the first spectrum analysis unit, acquiring the time from the lyrics inversion information, and calculating an imitative singing score.

12. The karaoke system according to claim 8, wherein the song learning score calculation unit comprises:
a pitch accuracy measurement unit for measuring accuracy of the pitch by receiving the reference pitch information from the pitch data extraction unit, receiving the analyzed user pitch information from the first spectrum analysis unit, and comparing the reference pitch information with the user pitch information;
a pitch transition similarity measurement unit for storing previous pitch data, calculating pitch transition by comparing the stored previous pitch data with the spectrum analysis information currently input from the first spectrum analysis unit, and measuring similarity between the calculated pitch transition and pitch transition of a song that is sung by the user;
a time score measurement unit for calculating a time score by comparing lyrics letter inversion time information with actually input user's input data;
an adder for calculating a song learning score by summing score values calculated by the pitch accuracy measurement unit, the pitch transition similarity measurement unit and the time score measurement unit; and
a score provision unit for calculating and then providing a score according to the environmental setting value set through the mode setting unit using instantaneous scores of respective bars through the adder.

13. The karaoke system according to claim 8, wherein the imitative singing score calculation unit comprises:
a tone color similarity measurement unit for receiving spectrum analysis information of the singer's voice, extracted from the singer's song, from the second spectrum analysis unit, as reference spectrum information, receiving the spectrum information of the user's voice from the first spectrum analysis unit, and measuring tone color similarity;
a tone color transition similarity measurement unit for calculating tone color transition through comparison with the spectrum analysis information input from the first spectrum analysis unit and measuring similarity between the calculated tone color transition, that is, reference information, and tone color transition of the user's song;
a time score measurement unit for calculating time score by comparing the lyrics letter inversion time information with actually input user's input data;
an adder for calculating a song learning score by summing score values calculated by the tone color similarity measurement unit, the tone color transition similarity measurement unit and the time score measurement unit; and
a score provision unit for calculating and then providing a score according to the environmental setting value set through the mode setting unit using instantaneous scores of respective bars through the adder.

14. The karaoke system according to claim 6, wherein the mode setting unit comprises mode setting information, including:
accompaniment mode for setting content data to be played;
score display mode for selecting whether to display one or more scores;
practice mode for setting song learning mode or imitative singing practice mode;
a playback/recording unit mode for setting complete playback/recording or bar-based playback/recording;
time setting mode for inserting mute intervals; and
bar length setting mode for setting a length of a bar in the case of the bar-based playback.

15. The karaoke system according to claim 14, wherein the score display mode information of the mode setting unit further comprises information about whether to display one or more bar-based scores.

16. The karaoke system according to claim 1, wherein the content data stored in the content storage means has an integrated file structure in which accompaniment sounds (MR) and a singer's song (AR) are integrated together.

17. The karaoke system according to claim 1, wherein the control means further comprises a process for enabling setting of an arbitrary interval so as to repeatedly play back the interval of accompaniment sounds or a singer's song during song practice, and the input means comprises input means for enabling the user to set the arbitrary interval that is desired to be repeatedly played back by the user.

18. The karaoke system according to claim 7, wherein the song accompaniment control unit comprises:
a file input/output processing unit for storing audio data, in which song accompaniment sounds are mixed with the user's voice input through a microphone, in a recorded data storage unit, and managing input and output of audio data stored in the recorded data storage unit;
a pitch/speed adjustment unit for adjusting a pitch and playback speed using data in which digital sounds have been decoded to the extent desired by the user;
an echo creation unit for performing feedback so as to apply an echo effect to microphone input audio signals; and
a mixer for mixing the user's voice signals, input through the microphone, with accompaniment data, input through the pitch/speed adjustment unit, and outputting resulting data to the audio conversion codec or file input/output processing unit.

19. The karaoke system according to claim 7, wherein the song accompaniment control unit comprises:
a file input/output processing unit for storing audio data, in which song accompaniment sounds are mixed with the user's voice input through a microphone, in a recorded data storage unit, and managing input and output of audio data stored in the recorded data storage unit;
a pitch/speed adjustment unit for adjusting a pitch and playback speed using data in which digital sounds have been decoded to the extent desired by the user; and
a mixer for mixing the user's voice signals, input through the microphone, with accompaniment data, input through the pitch/speed adjustment unit, and outputting resulting data to the audio conversion codec or file input/output processing unit.

20. A song learning method for a karaoke system having a song learning function, comprising:
a mode determination step of determining whether current mode is MR mode or AR mode;
a file determination step of determining whether a content file selected by a user is an integrated file or a separate file in which a singer's song AR or accompaniment sounds MR are separately provided;
a process of, if the current file is an integrated file and the current mode is MR mode, calculating a location pointer value of MR data recognized through an integrated file header, and, if the current file is an integrated file and the current mode is AR mode, calculating a location pointer value of AR data recognized through the integrated file header;
a step of, if the current file is not an integrated file and the current mode is MR mode, selecting an MR file corresponding to a currently selected file name and calculating a file pointer, and, if the current file is not an integrated file and the current mode is AR mode, selecting an AR file corresponding to a currently selected file name and calculating a file pointer;
a playback point calculation step for setting the calculated pointer to a reference pointer, obtaining a data offset value corresponding to current playback time, and adding the current playback time to the reference pointer;
a playback step of performing playback using the calculated playback pointer value;
a step of determining whether the playback has completed, and, if the playback has completed, checking whether repetition mode has been set; and
a step of, if the repetition mode has been set, repeating the playback a number of times set by the user using the playback pointer value, and, if the repetition mode has not been set, terminating the process.

21. The song learning method according to claim 20, further comprising a bar repetition playback step of determining whether the AR (MR) repetition input value has been input during playback of the singer's song or accompaniment sounds, and repeatedly playing back a current bar of AR (MR) data, wherein the bar repetition playback step comprises:
the step of, when the AR (MR) repetition key is pressed, stopping a song currently being played and moving to a first position of a current bar of the currently selected AR (MR) song;
the step of playing back AR (MR) data of the current bar;
a mute pitch determination step of, if the AR (MR) data playback of the current bar has completed, determining whether a mute pitch insertion value has been set in the mode setting unit;
a mute pitch insertion step of, if a mute pitch value has been set, inserting mute pitches between bars and bar playback at corresponding lengths using the mode set value set in the mode setting unit; and
the bar repetition playback step of determining whether the repetition number has been terminated, if the repetition number has not been terminated, moving to the first position of the current bar again and performing repetition playback by repeating the above steps, and, if the repetition number is exhausted, terminating the AR (MR) bar repetition playback.

22. The song learning method according to claim 20, further comprising an interval repetition playback step of determining whether AR (MR) repetition selection has been input during playback of the singer' song or accompaniment song, and repeatedly playing back a current interval of AR (MR) data, wherein the interval repetition playback step comprises:
the step of, if the AR (MR) repetition selection has been input, immediately stopping a song currently being played and determining whether a current location of the currently selected (AR) MR song falls within an interval designated by the user;
the step of, if the current location falls within an interval designated by the user, moving to a first position of the interval designated by the user and playing back AR (MR) data of the current interval, and, if the current location does not fall within an interval designated by the user, moving to a first position of a bar at the current location and playing back the AR (MR) data;
the mute pitch determination step of, if playback of the AR (DR) data of the current bar or current interval has completed, determining whether a mute pitch insertion value has been set in the mode setting unit;
the mute pitch insertion step of, if the mute pitch insertion value has been set, inserting mute pitches between bars and bar playback at corresponding lengths using the mode set value set in the mode setting unit; and
the step of determining whether the repetition number has been terminated, if the repetition number has been terminated, moving to a first position of the current bar or the current interval designed by the user, and performing repetition playback by repeating the above steps, and, if the repetition number has not been terminated, terminating the AR (MR) repetition playback.

23. The song learning method according to claim 20, further comprising a recording step of, depending on whether recording mode has been set in mode environment setting values in a mode setting unit, audio data in which the accompaniment sounds MR are synthesized with the user's voice input through a microphone; wherein the recording step includes:
the step of the user selecting accompaniment sounds MR and playing back the selected accompaniment sounds MR;
the mode determination step of initializing the recording mode, and determining whether the recording mode has been currently set by checking the program setting environment values set in the mode setting unit;
the step of, if the recording mode has been set, determining whether a bar-based recording function has been set, if the bar-based setting has been performed, performing the bar-based recording function, and, if the bar-based recording function has not been set, performing complete recording mode;
the step of, if the recording mode has not been set, determining whether recording selection input has been performed, and, if the recording selection has been input, moving to a first position of the accompaniment sounds, setting the recording mode, and performing complete recording;
the step of, if the recording selection has not been input, continuing the bar playback mode;
the step of periodically checking whether the song has been terminated according to a predetermined period, and, if the song has not been terminated, repeating the mode determination step;
the step of, if the song is terminated, checking whether a program has been terminated, and asking the user whether to store a file that has been recorded in line with the MR accompaniment sounds;
the step of, if the user selects recording, creating and storing the bar-based recorded file as integrated record data in which multiple pieces of bar-based recorded song data are connected to each other, and storing the completely recorded data in a file; and
the step of, if program termination has been input, terminating the program.

24. The song learning method according to claim 23, wherein the step of the user selecting accompaniment sounds MR and playing back the selected accompaniment sounds MR comprises, in the case of the accompaniment sounds bar repetition playback:
the step of, if the user selects recording, moving to a first position of a corresponding bar and setting recording mode;
the step of recording the current bar;
the step of, if the recording of the current bar has completed, asking the user whether to record current bar recorded data;
the step of, if the user selects storage, storing the recorded data;
the step of determining whether mute pitch insertion has been set in the mode setting unit, and, if the mute pitch insertion has been set, inserting mute intervals according to the set value; and
the step of determining whether the repetition number is exhausted, if the repetition number is exhausted, moving a first position of the current bar again and repeating MR bar repetition, and, if the repetition number is exhausted, terminating the MR bar repetition recording.

25. The song learning method according to claim 24, wherein the step of storing recorded data further comprises:
the step of determining whether bar data identical to that of the recorded data to be stored has been stored already; and
the step of, if the bar data to be stored has been stored already, deleting the stored recorded data and storing current data.

26. The song learning method according to claim 23, further comprising the recorded data playback step of selecting playback of the recorded data and enabling the user to determine whether to delete/store the corresponding data, wherein the recorded data playback step comprises:
the step or asking the user whether to listen to bar recorded data again;
the step of, if the user selects re-listening, playing back the record data;
the step of, at the step of playing back the recorded data, providing an evaluation score, thereby enabling the user to check the evaluation score and select whether to store the recorded data; and
the step of, according to the user's selection, determining whether to select or store the recorded data.

27. The song learning method according to claim 26, wherein in the provision of the evaluation score, the provided evaluation score further comprises bar-based evaluation scores.

28. In a digital device including digital signal processing means for providing a process for playback of multimedia source sounds or moving pictures, a karaoke system having a song learning function, comprising:
a memory unit for storing a control program, song accompaniment data, and accompaniment sound (MR) and singers' song (AR) data for song practice;
input means for enabling input of user selected values related to selection of songs for sound playback and song practice, control of playback/recording, and pitch, speed and echo adjustment for song accompaniment;
a recorded data storage unit for storing a user's song data during the user's song practice;
a text display control unit for processing text captions, such as lyrics captions and scores, for display means;
a display unit for displaying lyrics, scores and screens for song practice;
an audio conversion codec for converting digital signals into analog signals so as to play back and output digital data or converting the user's voice analog signals input through a microphone into digital signals;
the microphone for converting the user's voice into electrical signals;
a PC interface for connecting to a PC;
a system control unit including a practice control unit for controlling a series of processes for digital playback control, providing accompaniment sounds or a singer's song according to the user's selection, and providing a series of control processes related to playback/recording for the user's song practice; and
a song accompaniment control unit for providing processes for pitch and speed control for song accompaniment, echo adjustment and song accompaniment control.

29. The karaoke system according to claim 28, further comprising network connection means for connecting to a wired or wireless network, and receiving content data from a specific content data provision system, or providing stored data to an external system.

30. The karaoke system according to claim 28, wherein the song accompaniment control unit comprises:
a file input/output processing unit for storing audio data in which song accompaniment sounds have been mixed with the user's voice input through a microphone in a recorded data storage unit, outputting audio data stored in the recorded data storage unit to an outside, or receiving data from the outside and storing the data in the memory unit;
a pitch/speed adjustment unit for adjusting a pitch and playback speed using data in which digital sounds have been decoded to the extent desired by the user;
an echo creation unit for performing feedback so as to apply an echo effect to microphone input audio signals; and
a mixer for mixing the user's voice signals, input through the microphone, with accompaniment data, input through the pitch/speed adjustment unit, and outputting resulting data to the audio conversion codec or file input/output processing unit.

31. The karaoke system according to claim 30, wherein in the pitch/speed adjustment unit, a pitch adjustment unit comprises:
a window for dividing an original signal into signals at short intervals in a time plane;
a Fourier transform unit for performing Fourier transform on the signals at short intervals;
a spectrum shift for shifting an amplitude spectrum obtained by the Fourier transform unit to the extent desired by the user;
an inverse Fourier transform unit for performing inverse Fourier transform on the spectrum-shifted signals; and
a window for outputting signals changed through filtering so as to eliminate inconsistency between frames.

32. The karaoke system according to claim 30, wherein in the pitch/speed adjustment unit, a speed adjustment unit comprises:
a speed variation determination unit for, when an unvaried original signal is input, determining variation in speed of the input signal;
a decimation unit for, in the case of increase in speed, removing portions from the original signal
an interpolation unit for, in the case of decrease in speed, inserting data samples into the original signal;
a pitch (−) shift unit for outputting a signal varied by reducing a pitch so as to correct the pitch of a signal output from the decimation unit; and
a pitch (+) shift unit for outputting a signal varied by increasing a pitch so as to correct the pitch of a signal output from the interpolation unit.

33. The karaoke system according to claim 30, wherein the echo creation unit comprises:
a first adder M1 for synthesizing the input signal with the delayed feedback signal;
a delayer D1 for delaying an output signal of the first adder M1 by a predetermined time τ msec;
a reverberation time adjuster G2 for feeding back an output signal of the delayer D1 to the first adder M1 and adjusting reverberation time using a magnitude of resistance thereof;
a reverberation intensity adjuster G1 for adjusting reverberation intensity by adjusting intensity of the output signal of the delayer D1; and
a second adder M2 for outputting an echo-controlled signal obtained by synthesizing an output signal of the reverberation intensity adjuster G1 with the input signal.

34. The karaoke system according to claim 28, wherein the practice control unit comprises:
a mode setting unit for providing a process for setting operating mode for song practice and storing operating mode selected by the user;
a score calculation unit for calculating a score for result so the user's practice during song practice; and
a song practice control unit for controlling playback/recording of the accompaniment sounds or singers' songs, stored in the memory unit, according to environmental setting values set in a mode setting unit.
